(19) United States
(12) Patent Application Publication
(10) Pub. No.: US 2024/0373481 A1
(43) Pub. Date: Nov. 7, 2024

(54) METHOD OF ACCESS AND MOBILITY MANAGEMENT FUNCTION (AMF), METHOD OF USER EQUIPMENT(UE), AMF AND UE

(71) Applicant: NEC Corporation, Minato-ku, Tokyo (JP)

(72) Inventors: Iskren IANEV, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/572,278

(22) PCT Filed: Jun. 1, 2022
(86) PCT No.: PCT/JP2022/022368

§ 371 Date: Dec. 20, 2023

(30) Foreign Application Priority Data
Jun. 25, 2021 (IN) 202111028661

(51) Int. Cl. H04W 76/10

(52) U.S. Cl. CPC H04W 76/10

(57) ABSTRACT

[Problem]

This disclosure addresses how to define a mechanism for allocating the most suitable network slice to the UE or UE's PDU session in certain scenarios if a requested network slice from the UE is not allowed due to the Network Slice Admission Control.

Solution

A method of an Access and Mobility management Function (AMF) apparatus includes receiving, from a User Equipment (UE), first information related to a first network slice and second information related to a second network slice, and sending, to a Session Management Function (SMF) apparatus, the second information to establish a Protocol Data Unit (PDU) session on the second network slice in a case where the first network slice is overloaded.

### TECHNICAL FIELD

This present disclosure relates to a method of an Access and Mobility management Function (AMF) apparatus, a method of a User Equipment (UE), a method of a Network Slice Admission Control Function (NSACF) apparatus, a method of a Radio Access Network (RAN) Node, a method of a Policy Control Function (PCF) apparatus, an AMF apparatus, a UE, a NSACF apparatus, a RAN Node and a PCF apparatus.

### BACKGROUND ART

Network slicing features defined in 3GPP release 15 and release 16 enable a great variety of communication services for operators and verticals alike. Network Slicing is set to be a prominent feature of 5G system to allow connectivity and data processing tailored to specific requirements. Most of operators are considering that the 5G system will be managed based on network slicing technology. Although 3GPP has enhanced the network slicing feature since 3GPP release 15, some functional improvements on network slicing would be required while preparing a commercial 5G standalone system. Especially, the network slice selection is still based on static/limited information, i.e. the same network slice is selected for a given application/service at all times, regardless of the actual status in both UEs and networks. With dynamic steering of network slices, the operators can manage their network resources efficiently, and the user experience can be improved with the most suitable network slices.

In 3GPP release 18, the 3GPP SA1 Working Group (SA1 WG) performed Study on Enhanced Access to and Support of Network Slice. SA1 WG identified new use cases and new consolidated potential requirements for the enhanced supports for network slice. Based on the SA1 WG study, a new proposal for a study in 3GPP SA2 Working Group was presented in NPL 5 with the following objectives:

A mechanism for allocating the most suitable network slice to the UE or UE's PDU session in certain scenarios if:
a network slice currently being used by the UEs or currently being associated to the UE's PDU session needs to be terminated, modified or loaded, and therefore UEs or UE's PDU session need to be transferred from the network slice to another available network slice,
a certain scenario (e.g., a new dedicated flow is set up) requires the UE or some of UE's flows/PDU sessions to move to a new slice,
a requested network slice from the UE is not allowed due to the Network Slice Admission Control,
not all of the UE's subscribed network slices are supported by the same AMF(disjoint network slices), or
a UE is registered to the networks via 3GPP access and N3GPP (Non-3GPP) access simultaneously.

A mechanism for managing UE configuration with regard to Network Slicing:
A mechanism for using multiple URSPs in the UE if the UE is equipped with multi-SIMs.
A mechanism for determining Configured NSSAI, given that there is no restriction on the number of subscribed S-NSSAIs whereas Configured NSSAI per PLMN is 16 at maximum.

A mechanism for allocating/managing UP resources per a network slice

### CITATION LIST

### Non Patent Literature

[NPL 1] 3GPP TR 21.905: “Vocabulary for 3GPP Specifications” V17.0.0 (2020-07)-https://www.3gpp.org/ftp//Specs/archive/21_series/21.905/21905-h00.zip
[NPL 2] 3GPP TS 23.501: “System architecture for the 5G System (5GS)” V17.0.0 (2021-03)-https://www.3gpp.org/ftp/Specs/archive/23_series/23.501/23501-h00.zip
[NPL 3] 3GPP TS 23.502: “Procedures for the 5G System (5GS)” V17.0.0 (2021-03)-https://www.3gpp.org/ftp/Specs/archive/23_series/23.502/23502-h00.zip
[NPL 4] 3GPP TR 22.835: “Study on enhanced access to and support of network slices” V18.0.0 (2021-03)-https://www.3gpp.org/ftp/Specs/archive/22_series/22.835/22835-i00.zip
[NPL 5] 3GPP TSG, WG-SA WG2 Meeting #145E, 52-2104415: “Study on system enabler for Smarter use of Network Slices” (17-28 May 2021)-http://www.3gpp.org/ftp/tsg_sa/WG2_Arch/TSGS2_145E_Electroni c_2021-05/Docs/52-2104415.zip
[NPL 6] GSM Association Official Document NG.116: “Generic Network Slice Template” Version 2.0, 16 Oct. 2019-https://www.gsma.com/newsroom/wp-content/uploads/NG.116-v2.0.pdf

### SUMMARY OF INVENTION

### Technical Problem

This disclosure addresses a problem identified in the new Release 18 study proposal on network slices in NPL 5 in 3GPP SA2 Working Group, i.e. how to define a mechanism for allocating the most suitable network slice to the UE or UE's PDU session in certain scenarios if a requested network slice from the UE is not allowed due to the Network Slice Admission Control.

### Solution to Problem

In an aspect of the present disclosure, a method of an Access and Mobility management Function (AMF) apparatus includes receiving, from a User Equipment (UE), first information related to a first network slice and second information related to a second network slice, and sending, to a Session Management Function (SMF) apparatus, the second information to establish a Protocol Data Unit (PDU) session on the second network slice in a case where the first network slice is overloaded.

In an aspect of the present disclosure, a method of a User Equipment (UE) includes communicating with an Access and Mobility management Function (AMF) apparatus, and sending, to the AMF apparatus, first information related to a first network slice and second information related to a second network slice. A Protocol Data Unit (PDU) session is established on the second network slice instead of the first network slice in a case where the first network slice is overloaded.

In an aspect of the present disclosure, a method of a Network Slice Admission Control Function (NSACF) apparatus includes receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value, monitoring whether the first number or the second number reaches the predetermined threshold value, and sending, to the AMF apparatus, a notification indicating that the first number or the second number reaches the predetermined threshold value in a case where the first number or the second number reaches the predetermined threshold value.

In an aspect of the present disclosure, a method of an Access and Mobility management Function (AMF) apparatus includes receiving, from a Network Slice Admission Control Function (NSACF) apparatus, first information related to an overloaded network slice, receiving, from a User Equipment (UE), second information related to a first network slice, determining whether the first network slice is overloaded based on the first information, sending, to the UE, third information related to a second network slice in a case where the first network slice is overloaded, and receiving, from the UE, a message to establish a Protocol Data Unit (PDU) session on the second network slice. The message includes the third information.

In an aspect of the present disclosure, a method of a User Equipment (UE) includes sending, to an Access and Mobility management Function (AMF) apparatus, first information related to a first network slice, receiving, from the AMF apparatus, second information related to a second network slice in a case where the first network slice is overloaded, and sending, to the AMF apparatus, a message to establish a Protocol Data Unit (PDU) session on the second network slice. The message includes the second information.

In an aspect of the present disclosure, a method of an Access and Mobility management Function (AMF) apparatus includes receiving, from a Network Slice Admission Control Function (NSACF) apparatus, first information related to an overloaded network slice, and sending, to a Radio Access Network (RAN) Node, the first information and second information indicating that the overloaded network slice is suspended for registration or service.

In an aspect of the present disclosure, a method of a Radio Access Network (RAN) Node includes receiving, from an Access and Mobility management Function (AMF) apparatus, first information related to an overloaded network slice and second information indicating that the overloaded network slice is suspended for registration or service, and stopping broadcasting the first information.

In an aspect of the present disclosure, a method of a Radio Access Network (RAN) Node includes receiving, from an Access and Mobility management Function (AMF) apparatus, first information related to an overloaded network slice and second information indicating that the overloaded network slice is suspended for registration or service, and broadcasting the first information in information element indicating a network slice suspended for the registration or the service.

In an aspect of the present disclosure, a method of an Access and Mobility management Function (AMF) apparatus includes receiving, from a Network Slice Admission Control Function (NSACF) apparatus, first information related to an overloaded network slice, receiving, from a User Equipment (UE), second information related to a first network slice, determining whether the first network slice is overloaded based on the first information, and sending, to a Policy Control Function (PCF) apparatus, the second information to modify a Network Slice Selection Policy (NSSP) related to the first network slice in a case where the first network slice is overloaded.

In an aspect of the present disclosure, a method of a Policy Control Function (PCF) apparatus includes receiving, from an Access and Mobility management Function (AMF) apparatus, information related to an overloaded network slice, and modifying a Network Slice Selection Policy (NSSP) related to the overloaded network slice based on the information.

In an aspect of the present disclosure, an Access and Mobility management Function (AMF) apparatus includes means for receiving, from a User Equipment (UE), first information related to a first network slice and second information related to a second network slice, and means for sending, to a Session Management Function (SMF) apparatus, the second information to establish a Protocol Data Unit (PDU) session on the second network slice in a case where the first network slice is overloaded.

In an aspect of the present disclosure, a User Equipment (UE) includes means for communicating with an Access and Mobility management Function (AMF) apparatus, and means for sending, to the AMF apparatus, first information related to a first network slice and second information related to a second network slice. A Protocol Data Unit (PDU) session is established on the second network slice instead of the first network slice in a case where the first network slice is overloaded.

In an aspect of the present disclosure, a Network Slice Admission Control Function (NSACF) apparatus includes means for receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value, means for monitoring whether the first number or the second number reaches the predetermined threshold value, and means for sending, to the AMF apparatus, a notification indicating that the first number or the second number reaches the predetermined threshold value in a case where the first number or the second number reaches the predetermined threshold value.

In an aspect of the present disclosure, an Access and Mobility management Function (AMF) apparatus includes means for receiving, from a Network Slice Admission Control Function (NSACF) apparatus, first information related to an overloaded network slice, means for receiving, from a User Equipment (UE), second information related to a first network slice, means for determining whether the first network slice is overloaded based on the first information, means for sending, to the UE, third information related to a second network slice in a case where the first network slice is overloaded, and means for receiving, from the UE, a message to establish a Protocol Data Unit (PDU) session on the second network slice. The message includes the third information.

In an aspect of the present disclosure, a User Equipment (UE) includes means for sending, to an Access and Mobility management Function (AMF) apparatus, first information related to a first network slice, means for receiving, from the AMF apparatus, second information related to a second network slice in a case where the first network slice is overloaded, and means for sending, to the AMF apparatus, a message to establish a Protocol Data Unit (PDU) session on the second network slice. The message includes the second information.

In an aspect of the present disclosure, an Access and Mobility management Function (AMF) apparatus includes means for receiving, from a Network Slice Admission Control Function (NSACF) apparatus, first information related to an overloaded network slice, and means for sending, to a Radio Access Network (RAN) Node, the first information and second information indicating that the overloaded network slice is suspended for registration or service.

In an aspect of the present disclosure, a Radio Access Network (RAN) Node includes means for receiving, from an Access and Mobility management Function (AMF) apparatus, first information related to an overloaded network slice and second information indicating that the overloaded network slice is suspended for registration or service, and means for stopping broadcasting the first information.

In an aspect of the present disclosure, a Radio Access Network (RAN) Node includes means for receiving, from an Access and Mobility management Function (AMF) apparatus, first information related to an overloaded network slice and second information indicating that the overloaded network slice is suspended for registration or service, and means for broadcasting the first information in information element indicating a network slice suspended for the registration or the service.

In an aspect of the present disclosure, an Access and Mobility management Function (AMF) apparatus includes means for receiving, from a Network Slice Admission Control Function (NSACF) apparatus, first information related to an overloaded network slice, means for receiving, from a User Equipment (UE), second information related to a first network slice, means for determining whether the first network slice is overloaded based on the first information, and means for sending, to a Policy Control Function (PCF) apparatus, the second information to modify a Network Slice Selection Policy (NSSP) related to the first network slice in a case where the first network slice is overloaded.

In an aspect of the present disclosure, a Policy Control Function (PCF) apparatus includes means for receiving, from an Access and Mobility management Function (AMF) apparatus, information related to an overloaded network slice, and means for modifying a Network Slice Selection Policy (NSSP) related to the overloaded network slice based on the information.

### BRIEF DESCRIPTION OF DRAWINGS

FIG. 1 illustrates PDU Session Establishment on a compatible network slice in Aspect 1.

FIG. 2 illustrates PDU Session Establishment on a compatible network slice in Aspect 2.

FIG. 3 illustrates Network Slice broadcast suspension based on network slice status.

FIG. 4 illustrates URSP rules tuning based on the PDU Sessions per network slice status.

FIG. 5 illustrates System overview.

FIG. 6 is a block diagram for a User equipment (UE).

FIG. 7 is a block diagram for a (R)AN node.

FIG. 8 illustrates System overview of (R)AN node based on O-RAN architecture.

FIG. 9 is a block diagram for a Radio Unit (RU).

FIG. 10 is a block diagram for a Distributed Unit (DU).

FIG. 11 is a block diagram for a Centralized Unit (CU).

FIG. 12 is a block diagram for an AMF.

FIG. 13 is a block diagram for an SMF.

FIG. 14 is a block diagram for a PCF.

FIG. 15 is a block diagram for a UDM.

FIG. 16 is a block diagram for an NSACF.

### DESCRIPTION OF EMBODIMENTS

### Abbreviations

3GPP 3rd Generation Partnership Project
4G-GUTI 4G Globally Unique Temporary UE Identity
5G 5th Generation
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
ABBA Anti-Bidding-down Between Architectures
AF Application Function
AMF Access and Mobility Management Function
API Application Programming Interface
AS Access Stratum
ATSSS Access Traffic Steering, Switching, Splitting
ATSSS-LL ATSSS Low-Layer
AUSF Authentication Server Function
AUTN Authentication token
BBF Broadband Forum
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
CU Centralized Unit
DAPS Dual Active Protocol Stacks
DL Downlink
DN Data Network
DNAI DN Access Identifier
DNN Data Network Name
DRX Discontinuous Reception
DS-TT Device-side TSN translator
DU Distributed Unit
ePDG evolved Packet Data Gateway
EAP Extensible Authentication Protocol
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
gNB Next generation Note B
GPSI Generic Public Subscription Identifier
GSMA Global System for Mobile Communications
GST Generic Network Slice Template
GUAMI Globally Unique AMF Identifier
GUTI Globally Unique Temporary UE Identity
HR Home Routed (roaming)
IAB Integrated access and backhaul
IMEI International Mobile Equipment Identity
IMEI/TAC IMEI Type Allocation Code
IMS IP Multimedia Subsystem
IOWN Innovative Optical and Wireless Network
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
LTE Long Term Evolution
MAC Medium Access Control
MCC Mobile country code
MCX Mission Critical Service
MDBV Maximum Data Burst Volume
MFBR Maximum Flow Bit Rate
MICO Mobile Initiated Connection Only
MM Mobility Management
MNC Mobile Network Code
MNO Mobile Network Operator
MO Mobile Originated
MPS Multimedia Priority Service
MPTCP Multi-Path TCP Protocol
MT Mobile Terminated
MT Mobile Termination
N3IWF Non-3GPP InterWorking Function
N5CW Non-5G-Capable over WLAN
NAI Network Access Identifier
NAS Non-Access Stratum
NEF Network Exposure Function
NF Network Function
NGAP Next Generation Application Protocol
ngKSI Next Generation Key Set Identifier
NG-RAN Next Generation Radio Access Network
NID Network identifier
NPN Non-Public Network
NR New Radio
NRF Network Repository Function
NSAC Network Slice Admission Control
NSACF Network Slice Admission Control Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NW-TT Network-side TSN translator
NWDAF Network Data Analytics Function
O-RAN Open RAN Alliance
O-DU O-RAN Distributed Unit
O-CU O-RAN Centralized Unit
O-RU O-RAN Radio Unit
PCC Policy and Charging Control
PCF Policy Control Function
PDB Packet Delay Budget
PDCP Packet Data Convergence Protocol
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
QoS Quality of Service
RACS Radio Capabilities Signalling optimisation
(R)AN (Radio) Access Network
RG Residential Gateway
RU Radio Unit
RIM Remote Interference Management
RLC Radio Link Control
RQA Reflective QoS Attribute
RQI Reflective QoS Indication
RRC Radio Resource Control
RSN Redundancy Sequence Number
SA NR Standalone New Radio
SBA Service Based Architecture
SBI Service Based Interface
SCP Service Communication Proxy
SD Slice Differentiator
SDAP Service Data Adaptation Protocol
SEAF Security Anchor Functionality
SEPP Security Edge Protection Proxy
SMF Session Management Function
SMS Short Message Service
SMSF Short Message Service Function
SN Sequence Number
SN name Serving Network Name.
SNPN Stand-alone Non-Public Network
S-NSSAI Single Network Slice Selection Assistance
Information
SOR Steering Of Roaming
SSC Session and Service Continuity
SSCMSP Session and Service Continuity Mode Selection
Policy
SST Slice/Service Type
SUCI Subscription Concealed Identifier
SUPI Subscription Permanent Identifier
SV Software Version
TAI Tracking Area Identity
TCP Transmission Control Protocol
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UP User Plane
UPF User Plane Function
URLLC Ultra Reliable Low Latency Communication
URRP-AMF UE Reachability Request Parameter for AMF
URSP UE Route Selection Policy
UU Interface between User Equipment and Radio Access
Network
VID VLAN Identifier
VLAN Virtual Local Area Network
W-5GAN Wireline 5G Access Network
W-5GBAN Wireline BBF Access Network
W-5GCAN Wireline 5G Cable Access Network
W-AGF Wireline Access Gateway Function
WLAN Wireless Local Area Network
WUS Wake Up Signal

### Definitions

For the purposes of the present document, the terms and definitions given in NPL 1 and the following apply. A term defined in the present document takes precedence over the definition of the same term, if any, in NPL 1.

### Description of Disclosure with Aspects

Each of aspects and elements included in the each aspects described below may be implemented independently or in combination with any other. These aspects include novel characteristics different from one another. Accordingly, these aspects contribute to achieving objects or solving problems different from one another and contribute to obtaining advantages different from one another.

### <Aspect 1—PDU Session Establishment on a Compatible Network Slice>

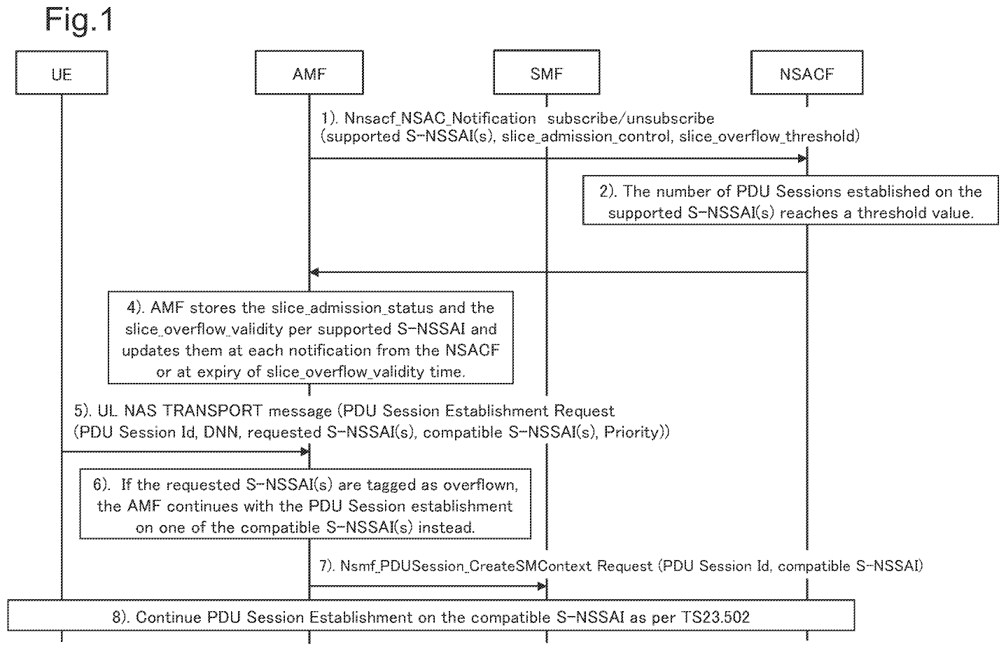

In Aspect 1, an AMF subscribes with a NSACF for notification. The NSACF sends a notification to the AMF when the number of the PDU Sessions established on supported network slice(s) subject to NSAC reaches or exceeds a threshold value. The threshold value is, for example, the maximum number of the PDU Sessions allowed to be established on the network slice(s) or a certain percentage of the maximum number. When the AMF receives, from the NSACF, such notification for network slice(s), the AMF stores the network slice(s) and tags them as ‘overflown’ (or overloaded or not available for access or any other notation to indicate that the overflown network slice reaches or exceeds its maximum number of established PDU Sessions) until another notification from the NSACF that indicates the network slice(s) become available again (or not overflown or not overloaded) or until expiry of slice_overflow_validity time, if the slice_overflow_validity time is provided by the NSACF in the slice_overflow_validity parameter. When the AMF receives, from the UE, PDU Session Establishment Request for the overflown network slice(s) as requested network slice(s) and the UE indicates one or more compatible network slice(s) (or the AMF retrieves one or more compatible network slice(s) information from a PCF), the AMF continues with PDU Session Establishment on one of the compatible network slice(s) instead of the requested network slice(s). FIG. 1 shows detailed processes.

1) An AMF subscribes with a NSACF for notification. The AMF sends an Nnsacf_NSAC_Notification subscribe message to the NSACF (Network Slice Admission Control Function) to subscribe for notifications. The Nnsacf_NSAC_Notification subscribe message indicates, for example, the AMF requests the NSACF to monitor the number of the PDU Sessions established on each one of the supported network slices.

The AMF includes, in the Nnsacf_NSAC_Notification subscribe message, as parameters, one or more supported S-NSSAI(s) that is subject to NSAC, slice_admission_control parameter or any other notation for a parameter to indicate that the required notification is about the number of the PDU Sessions on each of the indicated network slices and slice_overflow_threshold parameter or any other notation for a parameter defining the threshold value for triggering the notification from the NSACF.

The supported S-NSSAI(s) may indicate the supported network slice(s) which the AMF requests notification for.

The slice_admission_control parameter may be any other notation for a parameter to indicate that the required notification is about the number of the PDU Sessions on each of the indicated network slices. The slice_admission_control parameter may be information to indicate that the required notification is about the number of the PDU Sessions on each of the indicated network slices.

The slice_overflow_threshold parameter may be any other notation for a parameter defining the threshold value for triggering the notification from the NSACF. The slice_overflow_threshold parameter may be information defining the threshold value for triggering the notification from the NSACF. Alternatively, the slice_overflow_threshold parameter may be configured in the NSACF by the operator based on the operator's policy or provided to the NSACF from the UDM or the O&M (Operation and Maintenance). The slice_overflow_threshold parameter may be equal to the maximum number of PDU Sessions allowed to be established on the network slice. The slice_overflow_threshold parameter may be a percentage representation of the maximum number of the PDU Sessions allowed on the network slice. The slice_overflow_threshold parameter may be applicable to all network slices supported by the AMF (e.g. same threshold for all the network slices) or per a specific network slice only (e.g. each network slice may have different threshold).

The NSACF may send an acknowledgement to the AMF in response to the Nnsacf_NSAC_Notification subscribe message from the AMF. The AMF may send, to the NSACF, a message to unsubscribe the notifications. The message may be an Nnsacf_NSAC_Notification unsubscribe message. The Nnsacf_NSAC_Notification unsubscribe message may include the same parameters as the Nnsacf_NSAC_Notification subscribe message, i.e., supported S-NSSAI(s), slice_admission_control parameter and slice_overflow_threshold parameter.

2) The NSACF monitors the number of the PDU Sessions established on each one of the supported network slices which the AMF requests notification for. When the number of the PDU Sessions on one or more of the monitored network slice(s) reaches or exceeds the threshold value based on the slice_overflow_threshold parameter for that network slice(s), the NSACF triggers notification to the AMF. The threshold value is, for example, the maximum number of the PDU Sessions allowed to be established on the network slice or a certain percentage of the maximum number. The notification may be an Nnsacf_NSAC_Notification.

Similarly, when the number of the PDU Sessions on one or more of the monitored network slice(s) reaches or exceeds the threshold value once but starts decreasing and becomes less than the threshold value, the NSACF triggers notification to the AMF.

3) After receiving the Nnsacf_NSAC_Notification subscribe message, the NSACF is configured to send, to the AMF, a notification when the number of the PDU Sessions established on a network slice supported by the AMF reaches or exceeds a certain threshold value. The threshold value is, for example, the maximum number of the PDU Sessions allowed to be established on the network slice or a certain percentage of the maximum number. The NSACF sends an Nnsacf_NSAC_Notification message to the AMF. The NSACF includes, in the Nnsacf_NSAC_Notification message, parameters described below:
the supported S-NSSAI(s) indicating the supported network slice(s) which the AMF requests notification for;
slice_admission_status parameter which indicates whether the corresponding supported network slice is overflown or not overflown. The slice_admission_status parameter is a parameter per supported network slice. The ‘overflown’ may be any other notation, e.g. overloaded or not available for access, and the ‘not overflown’ may be another notation e.g. not overloaded or available for access. The NSACF returns ‘overflown’ value in the slice_admission_status parameter if the number of the PDU Sessions on the supported network slice reaches or exceeds the threshold value provided in the slice_overflown_threshold parameter. The NSACF returns ‘not overflown’ value in the slice_admission_status parameter if the number of the PDU Sessions on the supported network slice remains under the threshold value, or reaches or exceeds the threshold value once but starts decreasing and becomes less than the threshold value provided in the slice_overflow_threshold parameter;
slice_overflow_validity parameter which is an optional parameter. When the NSACF notifies ‘overflown’ value in the slice admission status parameter, the NSACF may also include a slice_overflow_validity parameter which defines slice_overflow_validity time for how long the network slice is overflown. The slice_overflow_validity parameter is a parameter per network slice which is overflown.

For example, when the number of the established PDU Sessions on a network slice indicated by S-NSSAI-1 as the supported S-NSSAI, reaches or exceeds the threshold value, the NSACF may send, to the AMF, the Nnsacf_NSAC_Notification message including the S-NSSAI-1 as the supported S-NSSAI, the slice_admission_status parameter which is set to ‘overflown’ value indicating that the network slice indicated by the S-NSSAI-1 is overflown, and the slice_overflow_validity parameter indicating how long the network slice indicated by the S-NSSAI-1 is overflown.

For example, when the number of the established PDU Sessions on a network slice indicated by S-NSSAI-1 as the supported S-NSSAI reaches or exceeds the threshold value once but starts decreasing and becomes less than the threshold value, the NSACF may send, to the AMF, the Nnsacf_NSAC_Notification message including the S-NSSAI-1 as the supported S-NSSAI and the slice_admission_status parameter which is set to ‘not overflown’ value indicating that a network slice indicated by the S-NSSAI-1 is not overflown.

4) The AMF stores overflown network slice(s) notified by the NSACF. The overflown network slice(s) may be the supported S-NSSAI(s) with the ‘overflown’ value set in the latest slice_admission_status parameter reported in the Nnsacf_NSAC_Notification message from the NSACF. The AMF may manage or maintain a list of the supported network slice(s) for storing the overflown network slice(s) notified by the NSACF. In the list of the supported network slice(s), each network slice is tagged as ‘overflown’ or ‘not overflown’ based on the latest slice_admission_status parameter in the Nnsacf_NSAC_Notification message from the NSACF. The list of the supported network slice(s) may be a list of the supported S-NSSAI(s). The list of the supported network slice(s) may include only a list of the overflown network slice(s) tagged as ‘overflown’ based on the latest slice_admission_status parameter.

If the NSACF provides the slice_overflow_validity parameter, at expiry of the slice_overflow_validity time for how long the network slice is over flown defined by the slice_overflow_validity parameter the AMF updates the tag of the related network slice from ‘overflown’ to ‘not overflown’ or removes the related network slice from the list of the overflown network slices tagged as ‘overflown’. In this way, the AMF maintains a list of S-NSSAI(s) that is overflown along with their slice_overflow_validity time based on the slice_overflow_validity parameter. The list of S-NSSAI(s) that is overflown may be a list of network slice(s) that is overflown. The AMF may use a timer to determine the expiry of the slice_overflow_validity time. The list of S-NSSAI(s) that is overflown may be a list of S-NSSAI(s) tagged with ‘overflown’. For example, if S-NSSAI-1 and S-NSSAI-2 are overflown, the list includes S-NSSAI-1 tagged as ‘overflown’ and S-NSSAI-2 tagged as ‘overflown’.

The list of S-NSSAI(s) or the list of S-NSSAI(s) that is overflown may be called as a list of the overflown network slices or the list of the network slices tagged as ‘overflown’. The list of S-NSSAI(s) that is overflown may be called as a list of the overflown S-NSSAI(s).

The AMF stores the slice admission status and the slice_overflow_validity per supported S-NSSAI and updates them at each notification from the NSACF or at expiry of the slice_overflow_validity time.

The examples for storing or maintaining the list are show below.

For example, when the AMF receives, from the NSACF, the Nnsacf_NSAC_Notification message including the S-NSSAI-1 as the supported S-NSSAI, the slice_admission_status parameter which is set to ‘overflown’ value indicating that the network slice indicated by S-NSSAI-1 is overflown, and the slice_overflow_validity parameter indicating time for how long the network slice indicated by S-NSSAI-1 is overflown, the AMF may store, in the list, information indicating that the network slice indicated by S-NSSAI-1 is overflown by tagging S-NSSAI-1 with ‘overflown’ value, and the slice_overflow_validity parameter for the S-NSSAI-1.

For example, when the AMF receives, from the NSACF, the slice_overflow_validity parameter for the S-NSSAI-1 and the AMF determines that the time defined by the slice_overflow_validity parameter expires, the AMF may remove the S-NSSAI-1 tagged with ‘overflown’ value and the slice_overflow_validity parameter for the S-NSSAI-1 from the list.

For example, when the AMF receives, from the NSACF, the Nnsacf_NSAC_Notification message including the slice_admission_status parameter which is set to ‘not overflown’ value indicating that the network slice indicated by the S-NSSAI-1 is not overflown, the AMF may remove the S-NSSAI-1 tagged with ‘overflown’ value and the slice_overflow_validity parameter for the S-NSSAI-1 from the list.

5) When a UE requires service, the UE sends, to the AMF, a UL NAS TRANSPORT message encapsulating the PDU Session Establishment Request message. The UE includes, in the PDU Session Establishment Request message, as parameters a PDU Session Id, DNN and requested S-NSSAI(s) on which the service is to be accessed or S-NSSAI(s) on which the PDU Session is to be established. The requested S-NSSAI(s) is one of the S-NSSAI(s) that the service triggering Application in the UE is mapped to by the NSSP (Network Slice Selection Policy) within the URSP (UE Route Selection Policy) in the UE Policy. The UE also includes, in the UL NAS TRANSPORT message, one or more additional S-NSSAI(s) called, for example, compatible S-NSSAI(s) or any other notation or information for S-NSSAI(s) on which the Application in the UE can also access the required service if the initially requested S-NSSAI(s) is not available, for example due to the ‘overflown’ value indicated by the NSACF. Note that the one or more additional S-NSSAI(s) may be included as compatible S-NSSAI(s) in the PDU Session Establishment Request message. The compatible S-NSSAI(s) may be S-NSSAI(s) on which the Application in the UE can also access the required service.

The UE may use the URSP rules in the UE Policy in order to derive one or more compatible S-NSSAI(s) to the network slice on which the UE requires a service (i.e. requested S-NSSAI(s)). For example, if the NSSP (Network Slice Selection Policy) mapping rules within the URSP rules are mapping the service requiring Application with several network slices, e.g. S-NSSAI-1, S-NSSAI-2, S-NSSAI-3 in this order, the UE would use the S-NSSAI-1 as the network slice on which it requests service (i.e. the requested S-NSSAI(s)) and the UE would use S-NSSAI-2 and S-NSSAI-3 as compatible network slices (or compatible S-NSSAI(s)).

6) When the AMF receives the UL NAS TRANSPORT message encapsulating the PDU Session Establishment Request message from the UE, the AMF first checks whether the received S-NSSAI(s) on which a service is requested (e.g. the requested S-NSSAI(s)) is overflown (i.e. the AMF checks whether the received S-NSSAI(s) is tagged as overflown or not in the AMF). The received S-NSSAI(s) may be called as the requested S-NSSAI(s). If the received S-NSSAI(s) is found in the list of the overflown network slices (i.e. if the AMF determines that the received S-NSSAI(s) is tagged as the overflown network slice), the AMF checks whether one of the compatible S-NSSAI(s) is not overflown (e.g. the AMF checks whether one of the compatible S-NSSAI(s) is not tagged as overflown in the AMF). For example, the AMF may check whether one of the compatible S-NSSAI(s) is not overflown by using the list of the overflown network slices. If the one of the compatible S-NSSAI(s) is not included in the list of the overflown network slices, the AMF determines that the one of the compatible S-NSSAI(s) is not overflown. The list of the overflown network slices may include S-NSSAI(s) tagged with the ‘overflown’ value.

Alternatively, the AMF may retrieve a compatible network slice (or a compatible S-NSSAI) directly from the URSP rules in the PCF. The compatible network slice can be a default S-NSSAI(s) for the UE.

If the requested S-NSSAI(s) are tagged as overflown, the AMF continues with the PDU Session establishment on one of the compatible S-NSSAI(s) instead.

7) If the one of the compatible S-NSSAI(s) is not overflown (e.g. if the AMF determines that the one of the compatible S-NSSAI(s) is not overflown or the AMF retrieves the one of the compatible S-NSSAI(s) based on the URSP rules), the AMF sends an Nsmf_PDUSession_CreateSMContext Request towards an SMF with the one of the compatible S-NSSAI(s) instead of the received S-NSSAI(s) from the UE. In this case the SMF is selected based on the one of the compatible S-NSSAI(s) and other parameters including the DNN. For example, in case of S-NSSAI-1 on which the service is requested, and S-NSSAI-2 as the compatible S-NSSAI, and in a case where a network slice indicated by the S-NSSAI-1 is overflown and a network slice indicated by the S-NSSAI-2 is not overflown, the AMF determines that the S-NSSAI-2 is not overflown and sends the Nsmf_PDUSession_CreateSMContext Request towards the SMF, by using the S-NSSAI-2 instead of the S-NSSAI-1.

The Nsmf_PDUSession_CreateSMContext Request includes PDU Session Id and the S-NSSAI-2 as the compatible S-NSSAI.

8) PDU Session Establishment on the compatible S-NSSAI(s) continues as per NPL 3.

In one example, the UE indicates S-NSSAI(s) that represents a Wild card S-NSSAI(s) or Null together with DNN in the UL NAS TRANSPORT message to the AMF in step 5. In this case, the AMF chooses the most suitable S-NSSAI(s) that can provide a service for the DNN out of the non-overflown S-NSSAI(s). In this case, the AMF proceeds to step 7 with the most suitable S-NSSAI(s) chosen by the AMF. For example, the AMF may choose the compatible S-NSSAI(s) out of the non-overflown S-NSSAI(s).

In another example, the UE may indicate a Priority parameter related to the compatible S-NSSAI(s) in the UL NAS TRANSPORT message to the AMF in step 5. If the UE provides a compatible S-NSSAI(s) with the Priority parameter, the AMF shall proceed with the PDU Session establishment on the compatible S-NSSAI(s) with a Priority even if a network slice indicated by the compatible S-NSSAI(s) is overflown. For example, the AMF receives an overflown value indication for S-NSSAI(s) from the NSACF. For example, the priority parameter indicates the compatible S-NSSAI(s) has priority. In this case, the AMF receives the S-NSSAI(s) as a requested S-NSSAI(s) in step 5 and the AMF proceeds to step 7 with the received S-NSSAI(s) from the UE. Note that the Priority parameter may be included to the PDU Session Establishment Request message as well. If the PDU Session Establishment procedure with the overflown S-NSSAI(s) is successfully performed, the AMF or the SMF invokes the Nnsacf_NumberOfUEsPerSliceAvailabilityCheckAndUpdate service to the NSACF with an indication of the priority handling, S-NSSAI(s) and UE ID (e.g. SUPI) so that the NSACF can manage a priority handing in the AMF.

### <Aspect 2—PDU Session Establishment on a Compatible Network Slice>

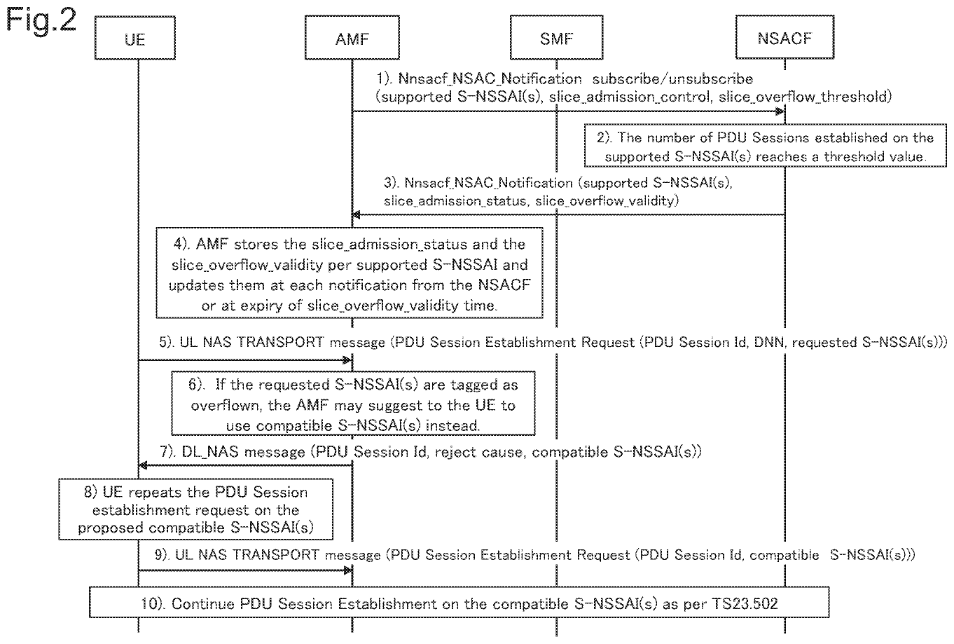

In Aspect 2, the AMF subscribes with the NSACF for notification. The NSACF sends the notification to the AMF when the number of the PDU Sessions established on supported network slice(s) subject to NSAC reaches or exceeds a threshold value. The threshold value is, for example, the maximum number of the PDU Sessions allowed to be established on the network slice(s) or a certain percentage of the maximum number. When the AMF receives, from the NSACF, such notification for network slice(s), the AMF stores the network slice(s) and tags them as ‘overflown’ (or overloaded or not available for access or any other notation to indicate that the overflown network slice reaches or exceeds its maximum number of established PDU Sessions) until another notification from the NSACF that indicates the network slice(s) become available again (or not overflown or not overloaded) or until expiry of the slice_overflow_validity time, if the slice_overflow_validity time is provided by the NSACF in the slice_overflow_validity parameter. When the AMF receives, from the UE, PDU Session Establishment Request for the overflown network slice(s) as the requested network slice(s), the AMF contacts back the UE via DL_NAS message suggesting an alternative network slice that is a compatible network slice with the requested network slice(s) by the UE which are found to be overflown. Then the UE triggers another PDU Session establishment request with the proposed compatible network slice. FIG. 2 shows detailed processes.

1) The AMF subscribes with the NSACF for notification. The AMF sends the Nnsacf_NSAC_Notification subscribe message to the NSACF (Network Slice Admission Control Function) to subscribe for notifications. The Nnsacf_NSAC_Notification subscribe message indicates, for example, the AMF request the NSACF to monitor the number of the PDU Sessions established on each one of the supported network slices.

The AMF includes, in the Nnsacf_NSAC_Notification subscribe message, as parameters one or more supported S-NSSAI(s) that is subject to NSAC, slice_admission_control parameter or any other notation for a parameter to indicate that the required notification is about the number of the PDU Sessions on the each of the indicated network slices and slice_overflow_threshold parameter or any other notation for a parameter defining the threshold value for triggering the notification from the NSACF.

The supported S-NSSAI(s) may indicate the supported network slice(s) which the AMF requests notification for.

The slice_admission_control parameter may be any other notation for a parameter to indicate that the required notification is about the number of the PDU Sessions on each of the indicated network slices. The slice_admission_control parameter may be information to indicate that the required notification is about the number of the PDU Sessions on each of the indicated network slices.

The slice_overflow_threshold parameter may be any other notation for a parameter defining the threshold value for triggering the notification from the NSACF. The slice_overflow_threshold parameter may be information defining the threshold value for triggering the notification from the NSACF.

Alternatively, the slice_overflow_threshold parameter may be configured in the NSACF by the operator based on the operator's policy or provided to the NSACF from the UDM or the O&M (Operation and Maintenance). The slice_overflow_threshold parameter may be equal to the maximum number of PDU Sessions allowed to be established on the network slice. The slice_overflow_threshold parameter may be a percentage representation of the maximum number of the PDU Sessions allowed on the network slice. The slice_overflow_threshold parameter may be applicable to all network slices supported by the AMF (e.g. same threshold for all the network slices) or per a specific network slice only (e.g. each network slice may have different threshold). The NSACF may send the acknowledgement to the AMF in response to the Nnsacf_NSAC_Notification subscribe message from the AMF. The AMF may send, to the NSACF, a message to unsubscribe the notifications. The message may be an Nnsacf_NSAC_Notification unsubscribe message. The Nnsacf_NSAC_Notification unsubscribe message may include the same parameters as the Nnsacf_NSAC_Notification subscribe message, i.e., supported S-NSSAI(s), slice_admission_control parameter and slice_overflow_threshold parameter.

2) The NSACF monitors the number of the PDU Sessions established on each one of the supported network slices which the AMF requests notification for. When the number of the PDU Sessions on one or more of the monitored network slice(s) reaches or exceeds the threshold value based on the slice_overflow_threshold parameter for that network slice(s), the NSACF triggers notification to the AMF. The threshold value is, for example, the maximum number of the PDU Sessions allowed to be established on the network slice or a certain percentage of the maximum number. The notification may be an Nnsacf_NSAC_Notification.

Similarly, when the number of the PDU Sessions on one or more of the monitored network slice(s) reaches or exceeds the threshold value once but starts decreasing and becomes less than the threshold value, the NSACF triggers notification to the AMF.

3) After receiving the Nnsacf_NSAC_Notification subscribe message, the NSACF is configured to send, to the AMF, a notification when the number of the PDU Sessions established on a network slice supported by the AMF reaches or exceeds a certain threshold value. The threshold value is, for example, the maximum number of the PDU Sessions allowed to be established on the network slice or a certain percentage of the maximum number. The NSACF sends the Nnsacf_NSAC_Notification message to the AMF. The NSACF includes, in the Nnsacf_NSAC_Notification message, parameters described below:
the supported S-NSSAI(s) indicating the supported network slice(s) which the AMF requests notification for;
the slice_admission_status parameter which indicates whether the corresponding supported network slice is overflown or not overflown. The slice_admission_status parameter is a parameter per supported network slice. The ‘overflown’ may be any other notation, e.g. overloaded or not available for access, and the ‘not overflown’ may be another notation e.g. not overloaded or available for access. The NSACF returns ‘overflown’ value in the slice_admission_status parameter if the number of the PDU Sessions on the supported network slice reaches or exceeds the threshold value provided in the slice_overflow_threshold parameter. The NSACF returns ‘not overflown’ value in the slice_admission_status parameter if the number of the PDU Sessions on the network slice remains under the threshold value, or reaches or exceeds the threshold value once but starts decreasing and becomes less than the threshold value provided in the slice_overflow_threshold parameter;
the slice_overflow_validity parameter which is an optional parameter. When the NSACF notifies ‘overflown’ value in the slice_admission_status parameter, the NSACF may also include a slice_overflow_validity parameter which defines slice_overflow_validity time for how long the network slice is overflown. The slice_overflow_validity parameter is a parameter per network slice which is overflown.

For example, when the number of the established PDU Sessions on a network slice indicated by S-NSSAI-1 as the supported S-NSSAI, reaches or exceeds the threshold value, the NSACF may send, to the AMF, the Nnsacf_NSAC_Notification message including the S-NSSAI-1 as the supported S-NSSAI, the slice_admission_status parameter which is set to ‘overflown’ value indicating that the network slice indicated by the S-NSSAI-1 is overflown, and the slice_overflow_validity parameter indicating how long the network slice indicated by the S-NSSAI-1 is overflown.

For example, when the number of the established PDU Sessions on a network slice indicated by S-NSSAI-1 as the supported S-NSSAI reaches or exceeds the threshold value once but starts decreasing and becomes less than the threshold value, the NSACF may send, to the AMF, the Nnsacf_NSAC_Notification message including the S-NSSAI-1 as the supported S-NSSAI and the slice_admission_status parameter which is set to ‘not overflown’ value indicating that a network slice indicated by the S-NSSAI-1 is not overflown.

4) The AMF stores the overflown network slice(s) notified by the NSACF. The overflown network slice(s) may be the supported S-NSSAI(s) with the ‘overflown’ value set in the latest slice_admission_status parameter reported in the Nnsacf_NSAC_Notification message from the NSACF. The AMF may manage or maintain a list of the supported network slice(s) for storing the overflown network slice(s) notified by the NSACF. In the list of the supported network slice(s), each network slice is tagged as ‘overflown’ or ‘not overflown’ based on the latest slice_admission_status parameter reported in the Nnsacf_NSAC_Notification message from the NSACF. The list of the supported network slice(s) may be a list of the supported S-NSSAI(s). The list of the supported network slice(s) may include only a list of the overflown network slice(s) tagged as ‘overflown’ based on the latest slice_admission_status parameter.

If the NSACF provides the slice_overflow_validity parameter, at expiry of the slice_overflow_validity time for how long the network slice is over flown defined by the slice_overflow_validity parameter the AMF updates the tag of the related network slice from ‘overflown’ to ‘not overflown’ or removes the related network slice from the list of the overflown network slices tagged as ‘overflown’. In this way, the AMF maintains a list of S-NSSAI(s) that is overflown along with their slice_overflow_validity time based on the slice_overflow_validity parameter. The list of S-NSSAI(s) that is overflown may be a list of network slice(s) that is overflown. The AMF may use a timer to determine the expiry of the slice_overflow_validity time. The list of S-NSSAI(s) that is overflown may be a list of S-NSSAI(s) tagged with ‘overflown’. For example, if S-NSSAI-1 and S-NSSAI-2 are overflown, the list includes S-NSSAI-1 tagged as ‘overflown’ and S-NSSAI-2 tagged as ‘overflown’.

The list of S-NSSAI(s) or the list of S-NSSAI(s) that is overflown may be called as a list of the overflown network slices or the list of the network slices tagged as ‘overflown’. The list of S-NSSAI(s) that is overflown may be called as a list of the overflown S-NSSAI(s).

The AMF stores the slice admission status and the slice_overflow_validity per supported S-NSSAI and updates them at each notification from the NSACF or at expiry of the slice_overflow_validity time.

The examples for storing or maintaining the list are in a same manner as the step 4 in Aspect 1.

5) When a UE requires service, the UE sends, to the AMF, a UL NAS TRANSPORT message encapsulating the PDU Session Establishment Request message. The UE includes, in the PDU Session Establishment Request message, as parameters a PDU Session Id, DNN and the requested S-NSSAI(s) on which the PDU Session is to be established (or the S-NSSAI(s) on which the service is to be accessed). The requested S-NSSAI(s) is one of the S-NSSAI(s) that the service triggering Application in the UE is mapped to by the NSSP (Network Slice Selection Policy) within the URSP (UE Route Selection Policy) in the UE Policy.

6) When the AMF receives the UL NAS TRANSPORT message encapsulating the PDU Session Establishment Request message from the UE, the AMF first checks whether the received S-NSSAI(s) on which a service is requested (e.g. the requested S-NSSAI(s)) is overflown (i.e. the AMF checks whether the received S-NSSAI(s) is tagged as overflown or not in the AMF). The received S-NSSAI(s) may be called as a requested S-NSSAI(s). If the received S-NSSAI(s) is found in the list of the overflown network slices (i.e. if the AMF determines that the received S-NSSAI(s) is tagged as the overflown network slice), the AMF may find S-NSSAI(s) which is compatible with the received S-NSSAI(s), called compatible S-NSSAI(s) (or any other notation for S-NSSAI(s) which can provide the same service as the received S-NSSAI(s)). The AMF may retrieve the UE's URSP from the PCF in order to decide the compatible S-NSSAI(s). For example, if the NSSP (Network Slice Selection Policy) mapping rules within the UE's URSP rules are mapping the service requiring Application with several network slices, e.g. S-NSSAI-1, S-NSSAI-2, S-NSSAI-3 in this order and the UE requested a service on the S-NSSAI-1, then S-NSSAI-2 and S-NSSAI-3 can be considered as compatible network slices. For example, in this case, the AMF may consider the S-NSSAI-2 and the S-NSSAI-3 as compatible network slices (or compatible S-NSSAI(s)).

The compatible network slice can be a default S-NSSAI(s) for the UE.

7) If the AMF manages to find another S-NSSAI(s) compatible to the requested S-NSSAI(s) (i.e. the AMF finds the compatible S-NSSAI(s)), the AMF provides that compatible S-NSSAI(s) to the UE via DL_NAS message. The AMF may choose the compatible S-NSSAI(s) from S-NSSAI(s) in the allowed NSSAI for the UE.

The AMF also includes, in the DL_NAS message, a reject cause value indicating that the S-NSSAI(s) (e.g. the requested S-NSSAI(s)) indicated in the UL NAS TRANSPORT message encapsulating the PDU Session Establishment Request message is rejected due to network slice overflow (or overload or unavailability). The reject cause value may indicate a PDU session establishment on the requested S-NSSAI(s) is rejected due to an overflow of the network slice indicated by the requested S-NSSAI(s).

The AMF also indicates, by using the DL_NAS message, to the UE that the UE may send, to the AMF, the UL NAS TRANSPORT message encapsulating the PDU Session Establishment Request message with the compatible S-NSSAI(s). For example, the AMF may suggest the UE to use the compatible S-NSSAI(s) instead of the requested S-NSSAI(s). In addition, for example, the AMF may include, in the DL_NAS message, information indicating that the UE may send, to the AMF, the UL NAS TRANSPORT message encapsulating the PDU Session Establishment Request message with the compatible S-NSSAI(s).

The AMF may also include, in the DL_NAS message, a back-off timer for the requested S-NSSAI(s). A timer value for the back-off timer may be based on the slice_overflow_validity parameter received from the NSACF in step 3. For example, after the back-off timer for the requested S-NSSAI(s) expires, the UE may use the requested S-NSSAI(s) for the PDU Session Establishment Request message.

In case that the received compatible S-NSSAI(s) from the AMF is not in the allowed NSSAI, the UE shall perform the registration procedure by sending the Registration Request message to the AMF with the received compatible S-NSSAI(s) putting into the requested NSSAI parameter. Once the registration procedure is completed successfully and the received compatible S-NSSAI(s) is in the allowed NSSAI as the result, the UE can proceed with step 8.

8) When the UE receives DL_NAS message including the compatible S-NSSAI(s), the UE repeats its request for a PDU Session establishment on the compatible S-NSSAI(s).

9) The UE triggers a new PDU Session establishment request procedure with the provided compatible S-NSSAI(s) by sending, to the AMF, the UL NAS TRANSPORT message with the PDU Session Establishment Request message encapsulated with the compatible S-NSSAI(s). For example, the UE sends, to the AMF, the UL NAS TRANSPORT message encapsulating the PDU Session Establishment Request message which includes the compatible S-NSSAI(s).

10) The AMF continues with the PDU Session Establishment on the compatible S-NSSAI(s) as per NPL 3.

### <Aspect 3—Network Slice Broadcast Suspension Based on Network Slice Status>

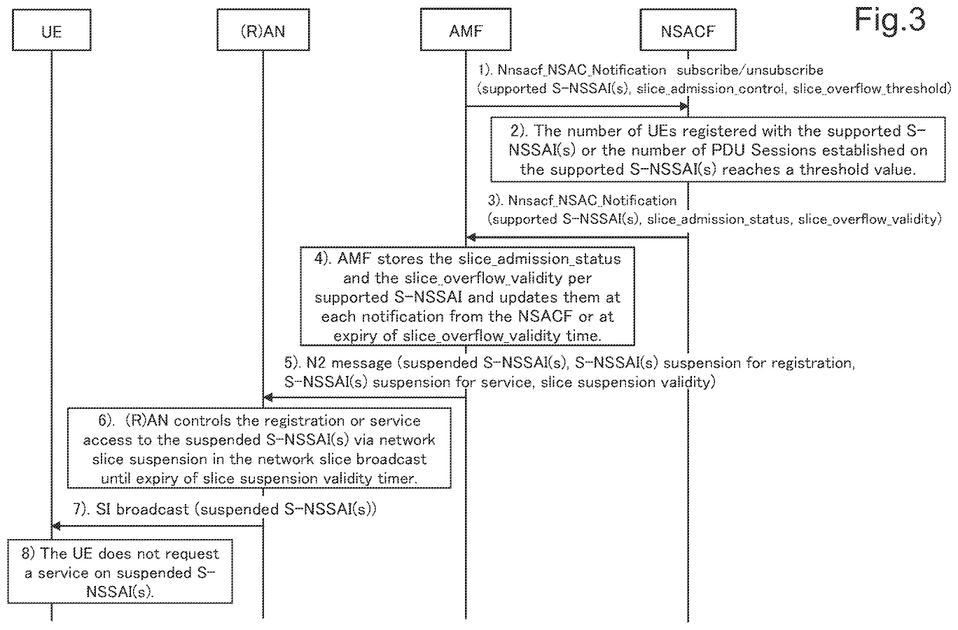

In Aspect 3, the AMF subscribes with the NSACF for notification. The NSACF sends the notification to the AMF when the number of the UEs registered with a network slice(s) subject to NSAC or the number of the PDU Sessions established on a network slice(s) subject to NSAC reaches or exceeds a threshold value. The threshold value is, for example, the maximum number of the UEs registered with a network slice(s) or the maximum number of the PDU Sessions allowed to be established on the network slice(s) or a certain percentage of the maximum number. When the AMF receives, from the NSACF, such notification for a network slice(s), the AMF stores the network slice(s) and tags them as ‘overflown’ (or overloaded or not available for access or any other notation to indicate that the overflown network slice reaches or exceeds its maximum number of established PDU Sessions) until another notification from the NSACF that indicates the network slice(s) become available again (or not overflown or not overloaded) or until the expiry of the slice_overflow_validity time, if the slice_overflow_validity time is provided by the NSACF in the slice_overflow_validity parameter. The AMF forwards these overflown network slices to the RAN Node by using the N2 message including the parameter called suspended S-NSSAI(s) along with a slice suspension validity parameter with a time value provided in the slice_overflow_validity parameter from the NSACF. Then the RAN Node either broadcasts the suspended network slices in a new suspended S-NSSAI(s) parameter or alternatively does not include the suspended network slices in the supported NSSAIs broadcast for the duration of time indicated by the slice suspension validity parameter, if any. The UE does not trigger a service request to a network slice that is broadcast as a suspended S-NSSAI(s). The RAN Node may be called as (R)AN Node. FIG. 3 shows detailed processes.

1). The AMF subscribes with a NSACF for notification. The AMF sends the Nnsacf_NSAC_Notification subscribe message to the NSACF (Network Slice Admission Control Function) to subscribe for notifications. The Nnsacf_NSAC_Notification subscribe message indicates, for example, the AMF requests the NSACF to monitor the number of the UEs registered with network slice(s) subject to NSAC or the number of the PDU Sessions established on each one of the network slices supported by the AMF (or subject to NSAC).

The AMF includes, in Nnsacf_NSAC_Notification subscribe message, as parameters one or more supported S-NSSAI(s) that is subject to NSAC, the slice_admission_control parameter or any other notation for a parameter to indicate that the required notification is about the number of registered UEs or the number of the PDU Sessions on the each of the indicated network slices and slice_overflow_threshold parameter or any other notation for a parameter defining the threshold value for triggering the notification from the NSACF.

The supported S-NSSAI(s) may indicate the supported network slice(s) which the AMF requests notification for.

The slice_admission_control parameter may be any other notation for a parameter to indicate that the required notification is about the number of registered UEs or the number of the PDU Sessions on the each of the indicated network slices. The slice_admission_control parameter may be information to indicate that the required notification is about the number of registered UEs or the number of the PDU Sessions on the each of the indicated network slices.

The slice_overflow_threshold parameter may be any other notation for a parameter defining the threshold value for triggering the notification from the NSACF. The slice_overflow_threshold parameter may be information defining the threshold value for triggering the notification from the NSACF.

Alternatively, the slice_overflow_threshold parameter may be configured in the NSACF by the operator based on the operator's policy or provided to the NSACF from the UDM or the O&M (Operation and Maintenance). The slice_overflow_threshold parameter may be equal to the maximum number of the UEs registered with a network slice or the maximum number of the PDU Sessions allowed to be established on the network slice. The slice_overflow_threshold parameter may be a percentage representation of the maximum number. The slice_overflow_threshold parameter may be applicable to all network slices supported by the AMF (e.g. same threshold for all the network slices) or per a specific network slice only (e.g. each network slice may have different threshold).

The NSACF may send the acknowledgement to the AMF in response to the Nnsacf_NSAC_Notification subscribe message from the AMF. The AMF may send, to the NSACF, a message to unsubscribe the notifications. The message may be an Nnsacf_NSAC_Notification unsubscribe message. The Nnsacf_NSAC_Notification unsubscribe message may include the same parameters as the Nnsacf_NSAC_Notification subscribe message, i.e., supported S-NSSAI(s), slice_admission_control parameter and slice_overflow_threshold parameter.

2) The NSACF monitors the number of the PDU Sessions established on each one of the supported network slices which the AMF requests notification for or the number of registered UEs which the AMF requested notification for. When the number of registered UEs or the number of the PDU Sessions on one or more of the monitored network slices reaches or exceeds the threshold value based on the slice_overflow_threshold parameter for that network slice(s), the NSACF triggers notification to the AMF. The threshold value is, for example, the maximum number of UEs allowed to register on the network slice or the maximum number of the PDU Sessions allowed to be established on the network slice or a certain percentage of the maximum number. The notification may be an Nnsacf_NSAC_Notification.

Similarly, when the number of registered UEs or the number of the PDU Sessions on one or more of the monitored network slices reaches or exceeds the threshold value once but starts decreasing and becomes less than the threshold value, the NSACF triggers notification to the AMF.

The slice_overflow_threshold parameter may alternatively be configured in the NSACF or provided to the NSACF from the UDM or the O&M.

The same threshold value based on the slice_overflow_threshold parameter may be configured for both the number of the established PDU Sessions on a network slice and the number of the UEs registered on a network slice. The different threshold value based on the slice_overflow_threshold parameter may be configured for the number of the established PDU Sessions on a network slice and the number of the UEs registered on a network slice respectively.

3) After receiving the Nnsacf_NSAC_Notification subscribe message, the NSACF is configured to send, to the AMF, a notification when the number of the UEs registered with a network slice subject to NSAC or the number of the PDU Sessions established on a network slice supported by the AMF (or subject to NSAC) reaches or exceeds a certain threshold value. The threshold value is, for example, the maximum number of the UEs registered with a network slice or the maximum number of the PDU Sessions allowed to be established on the network slice or a certain percentage of the maximum number. The NSACF sends Nnsacf_NSAC_Notification message to the AMF. The NSACF includes, in Nnsacf_NSAC_Notification message, parameters described below:
the supported S-NSSAI(s) indicating the supported network slice(s) which the AMF requests notification for.
the slice_admission_status parameter which indicates whether the network slice is overflown (e.g. not available or overloaded for access) or not overflown (e.g. available for access or not overloaded). The NSACF returns the following status values in the slice_admission_status parameter:
‘overflown for UE registrations’ status value in the slice_admission_status parameter if the number of the UEs registered with the network slice has reached or exceeded the threshold value provided in the slice_overflown_threshold parameter; or
‘overflown for PDU Sessions’ status value in the slice_admission_status parameter if the number of the PDU Sessions on the network slice has reached or exceeded the threshold value provided in the slice_overflow_threshold parameter; or
‘not overflown’ value in the slice admission status' parameter if the number of the registered UEs AND the number of the established PDU Sessions on the network slice are maintained or have dropped below the threshold value provided in the slice_overflow_threshold parameter;
the slice_overflow_validity parameter which is an optional parameter. When the NSACF notifies ‘overflown for UE registrations’ status value or ‘overflown for PDU Sessions’ status value in the slice_admission_status parameter, the NSACF may also include a slice_overflow_validity parameter which defines for how long the network slice is overflown (e.g. overloaded or not available).

For example, when the number of the established PDU Sessions on a network slice indicated by S-NSSAI-1 reaches or exceeds the threshold value, the NSACF may send, to the AMF, the Nnsacf_NSAC_Notification message including the S-NSSAI-1, the slice_admission_status parameter which is set to ‘overflown for PDU Sessions’ status value indicating that the network slice indicated by the S-NSSAI-1 is overflown, and the slice_overflow_validity parameter indicating how long the network slice indicated by the S-NSSAI-1 is overflown.

For example, when the number of the UEs registered on a network slice indicated by S-NSSAI-1 reaches or exceeds the threshold value, the NSACF may send, to the AMF, the Nnsacf_NSAC_Notification message including the S-NSSAI-1, the slice_admission_status parameter which is set to ‘overflown for UE registrations’ status value indicating that the network slice indicated by the S-NSSAI-1 is overflown, and the slice_overflow_validity parameter indicating how long the S-NSSAI-1 is overflown.

For example, when the number of the established PDU Sessions on a network slice indicated by S-NSSAI-1 or the number of the UEs registered on a network slice indicated by the S-NSSAI-1 reaches or exceeds the threshold value once but the number of the established PDU Sessions on the network slice indicated by the S-NSSAI-1 and the number of the UEs registered on the network slice indicated by the S-NSSAI-1 start decreasing and become less than the threshold value, the NSACF may send, to the AMF, the Nnsacf_NSAC_Notification message including the slice admission status parameter which is set to ‘not overflown’ value indicating that the network slice indicated by the S-NSSAI-1 is not overflown.

4) The AMF stores the overflown network slices notified by the NSACF and tags each one as ‘overflown for UE registration’ or ‘overflown for PDU Sessions’ or ‘not overflown’ based on the latest slice_admission_status parameter reported in the Nnsacf_NSAC_Notification message from the NSACF. The AMF may manage or maintain a list of the network slices (e.g. a list of S-NSSAI(s)) for storing the network slices notified by the NSACF and for tagging each one as ‘overflown for UE registration’ or ‘overflown for PDU Sessions’ or ‘not overflown’ based on the latest slice_admission_status parameter reported in the Nnsacf_NSAC_Notification message from the NSACF.

If the NSACF provides the slice_overflown_validity parameter, at expiry of the slice_overflown_validity time the AMF removes the related network slice from the list of the network slices tagged as ‘overflown for UE registration’ or ‘overflown for PDU Sessions’. In this way, the AMF maintains a list of S-NSSAI(s) that is overflown along with their overflow validity time based on the slice_overflow_validity parameter.

For example, the AMF may store or maintain the list in a same manner as the step 4 in Aspect 1.

5) If the NSACF notified the AMF that one or more network slices are overflown (e.g. overloaded or unavailable), the AMF forwards these overflown network slices (e.g. S-NSSAI(s) for the overflown network slice(s)) to the RAN Node within the N2 message (or within any other message on the interface between the AMF and the RAN Node, e.g. NAS Assistance information message).

In addition, the AMF may include a slice suspension validity parameter in the N2 message, and sent the N2 message to the RAN Node. The slice suspension validity parameter defines how long the RAN Node performs suspension for the one or more overflown network slices. Time defined by the suspension validity parameter may be based on the slice_overflow_validity parameter. For example, time defined by the suspension validity parameter is same to time defined by the slice_overflow_validity parameter. For example, the AMF may determine the time based on the time defined by the slice suspension validity parameter based on the slice_overflow_validity parameter.

Further, the AMF sends, to the RAN Node, parameter as shown below within the N2 message (or within any other message on the interface between the AMF and the RAN Node, e.g. NAS Assistance information message):
‘S-NSSAI(s) suspension for registration’ parameter or any other notation for a parameter to indicate to the RAN Node that the included one or more network slices (e.g. S-NSSAI(s) for the overflown network slice(s)) are suspended for registration until notified for the suspension lift in one of the following notifications or for the duration of the time provided in the slice suspension validity parameter, if included;
‘S-NSSAI(s) suspension for service’ parameter or any other notation for a parameter to indicate to the RAN Node that the included one or more network slices (e.g. S-NSSAI(s) for the overflown network slice(s)) are suspended for service (e.g. PDU Session establishment) until notified for the suspension lift in one of the following notifications or for the duration of the validity time provided in the slice suspension validity parameter, if included; For example, the AMF sends, to the RAN Node, the above N2 message to request the RAN Node for network slice suspension. The S-NSSAI(s) for the overflown network slice(s) may be called as suspended S-NSSAI(s).

For example, when the AMF receives, from the NSACF, the Nnsacf_NSAC_Notification message including S-NSSAI-1 on which the number of the UEs registered on a network slice has reached the threshold value, the ‘overflown for UE registrations’ status value for the S-NSSAI-1, and the slice_overflow_validity parameter for the S-NSSAI-1, the AMF sends, to the RAN Node, the N2 message including the S-NSSAI-1, the ‘S-NSSAI(s) suspension for registration’ parameter for the S-NSSAI-1 and the slice suspension validity parameter for the S-NSSAI-1.

For example, when the AMF receives, from the NSACF, the Nnsacf_NSAC_Notification message including the S-NSSAI-1 on which the number of the PDU Sessions on a network slice has reached the threshold value, the ‘overflown for PDU Sessions’ status value for the S-NSSAI-1, and the slice_overflow_validity parameter for the S-NSSAI-1, the AMF sends, to the RAN Node, the N2 message including the S-NSSAI-1, the ‘S-NSSAI(s) suspension for service’ parameter for the S-NSSAI-1 and the slice suspension validity parameter for the S-NSSAI-1.

The S-NSSAI(s) on which the number of the UEs registered on a network slice has reached the threshold value may be called as the S-NSSAI(s) for the overflown network slice(s) or the suspended S-NSSAI(s).

The ‘S-NSSAI(s) suspension for registration’ parameter may be called as information indicating that one or more overflown network slices are suspended or unusable for registration. The ‘S-NSSAI(s) suspension for service’ parameter may be called as information indicating that one or more overflown network slices are suspended or unusable for service (e.g. Service Request or PDU Session establishment).

Alternatively, if the NSACF notified the AMF that one or more network slices are maintained or not overflown (e.g. if the number of the PDU Sessions or the number of registered UEs on the network slice have dropped below the threshold value), the AMF forwards these network slices (e.g. S-NSSAI(s) for the not-overflown network slice(s)) to the RAN Node within the N2 message (or within any other message on the AMF/RAN interface e.g. NAS Assistance information message). In addition, the AMF sends, to the RAN Node, parameter as shown below within the N2 message (or within any other message on the interface between the AMF and the RAN Node, e.g. NAS Assistance information message):
‘S-NSSAI(s) become operational for registration’ parameter or any other notation for a parameter to indicate to the RAN Node that the included one or more network slices (e.g. S-NSSAI(s) for the not-overflown network slice(s)) are become operational for registration;
‘S-NSSAI(s) become operational for service’ parameter or any other notation for a parameter to indicate to the RAN Node that the included one or more network slices (e.g. S-NSSAI(s) for the not-overflown network slice(s)) are become operational for service (e.g. PDU Session establishment);

For example, when the number of registered UEs on a network slice indicated by S-NSSAI-1 have dropped below the threshold value and the AMF receives, from the NSACF, the Nnsacf_NSAC_Notification message including the slice_admission_status parameter which is set to ‘not overflown’ value indicating that the network slice indicated by the S-NSSAI-1 is not overflown, the AMF sends, to the RAN Node, the N2 message including the ‘S-NSSAI(s) become operational for registration’ parameter for the S-NSSAI-1.

For example, when the number of the PDU Sessions on a network slice indicated by S-NSSAI-1 have dropped below the threshold value and the AMF receives, from the NSACF, the Nnsacf_NSAC_Notification message including the slice_admission_status parameter which is set to ‘not overflown’ value indicating that the network slice indicated by the S-NSSAI-1 is not overflown, the AMF sends, to the RAN Node, the N2 message including the ‘S-NSSAI(s) become operational for service’ parameter for the S-NSSAI-1.

6) If the RAN Node receives a request for network slice suspension in the N2 message from the AMF, the RAN Node:
if the suspension is for UE registrations (e.g. if the RAN node receives the ‘S-NSSAI(s) suspension for registration’ parameter), the RAN Node stops broadcasting the suspended S-NSSAI(s) as supported network slice(s) (e.g. supported S-NSSAI(s)) in the System Information (SI) broadcast message(s), or alternatively, the RAN Node broadcasts the suspended S-NSSAI(s) in a new ‘suspended S-NSSAI(s)’ information element in the SI broadcast message(s) or any other notation for information element that includes one or more S-NSSAI(s) that are suspended or not allowed for registration until the suspension is lifted e.g. the suspended S-NSSAI(s) are removed from the suspended S-NSSAI(s) information element. The SI broadcast message may be called as system information message.
if the suspension is for service access (e.g. PDU Sessions establishment), the RAN Node may move (or set) the suspended S-NSSAI(s) into the suspended S-NSSAI(s) information element in the System Information (SI) broadcast message(s).

When the suspension is lifted by the AMF (e.g. when the current suspended network slices (e.g. the suspended S-NSSAI(s)) are moved by the AMF from the suspended S-NSSAI(s) parameter to the supported S-NSSAI(s) parameter list within the N2 message or when the slice_overflow_validity time indicated by the slice_overflow_validity parameter (if the slice_overflow_validity parameter is received by the AMF) expires), the RAN Node lifts the suspension by starting to broadcast these formerly suspended S-NSSAI(s) within the supported network slices information element in the System Information broadcast message(s).

For example, when the AMF decides to lift the suspension (e.g. the AMF decides to lift moving (or setting) the suspended S-NSSAI-1 into the suspended S-NSSAI(s) information element in the SI broadcast message(s)), the AMF requests, by using the N2 message, the RAN Node to move the suspended S-NSSAI-1 from the suspended S-NSSAI(s) information element of the SI broadcast message to the supported S-NSSAI(s) information element of the SI broadcast message. When the RAN Node receives the N2 message to lift the suspension, the RAN Node moves the suspended S-NSSAI-1 from the suspended S-NSSAI(s) information element to the supported S-NSSAI(s) information element, and starts to broadcast the suspended S-NSSAI-1 within the supported S-NSSAI(s) information element in the SI broadcast message. For example, when the AMF receives, from the NSACF, the Nnsacf_NSAC_Notification message including the slice_admission_status parameter which is set to ‘not overflown’ value for the S-NSSAI-1, the AMF decides to lift the suspension.

For example, when the AMF determines that the slice_overflow_validity time for the S-NSSAI-1 expires, the AMF may request, by using the N2 message, the RAN Node to move the suspended S-NSSAI-1 from the suspended S-NSSAI(s) information element to the supported S-NSSAI(s) information element.
if the suspension is over for UE registrations (e.g. the RAN Node receives the ‘S-NSSAI(s) become operational for registration’ parameter or the RAN Node determines that time indicated by slice suspension validity parameter expires), the RAN Node starts to broadcast the suspended S-NSSAI(s) as supported network slice(s) in the System Information broadcast message(s).
if the suspension is over for service access (e.g. PDU Sessions establishment), the RAN Node may remove the suspended S-NSSAI(s) from the suspended S-NSSAI(s) information element in the System Information broadcast message(s). For example, the RAN Node receives the ‘S-NSSAI(s) become operational for service’ parameter or the RAN Node determines that time indicated by the slice suspension validity parameter expires, the RAN Node removes the suspended S-NSSAI(s) from the suspended S-NSSAI(s) information element in the System Information broadcast message(s). The RAN Node starts to broadcast the suspended S-NSSAI(s) as supported network slice(s) (or the supported S-NSSAI(s)) in the System Information broadcast message(s).

The RAN controls the registration or service access to the suspended S-NSSAI(s) via network slice suspension in the network slice broadcast until expiry of slice suspension validity timer.

7) When the RAN node receives the ‘S-NSSAI(s) suspension for registration’ parameter or the ‘S-NSSAI(s) suspension for service’ parameter from the AMF, the RAN Node broadcasts the suspended S-NSSAI(s) in a new parameter within the System Information broadcast messages. The new parameter may be called as ‘suspended S-NSSAI(s)’, ‘suspended S-NSSAI(s) information element’ or any other notation for a parameter which contains S-NSSAI(s) that currently are suspended i.e. overflown, not available or overloaded.

8) The UE reads regularly the SI broadcast message(s). If the SI broadcast message(s) contains suspended S-NSSAI(s), the UE does not trigger a service (e.g. Service Request or PDU Session establishment) on the suspended network slice(s) related to the suspended S-NSSAI(s) for the duration of the suspension or until the UE re-selects to another cell where the required slice is not suspended anymore. In cell re-selection, if there are several neighbor cells qualifying for a cell reselection, the UE gives priority to cells in which the UE registered network slices are not suspended. The UE may trigger a service (e.g. Service Request or PDU Session establishment) on the suspended network slice(s) related to the suspended S-NSSAI(s) after the RAN Node broadcasts the suspended S-NSSAI(s) as supported network slice(s) (or the supported S-NSSAI(s)) in the System Information broadcast message(s). The suspended S-NSSAI(s) may be called as S-NSSAI(s) which the UE does not use for a service (e.g. Service Request or PDU Session establishment). In addition, the suspended S-NSSAI(s) may be called as S-NSSAI(s) which are suspended or unusable for a service (e.g. Service Request or PDU Session establishment). For example, when the UE receive the SI broadcast message(s) including the suspended S-NSSAI(s), the UE understand that the network slice indicated by the suspended S-NSSAI(s) is overflown and is unusable for the service. The suspended S-NSSAI(s) may mean that the network slice indicated by the suspended S-NSSAI(s) is overflown and is unusable for the service.

In one example, the RAN Node rejects the RRC Setup Complete message from the UE if the RRC Setup Complete message includes one or some S-NSSAI(s) that is subject for the suspension for UE registrations. The one or some S-NSSAI(s) that is subject for the suspension for UE registrations may be called as the suspended S-NSSAI(s). This can be happen for example, when the UE does not support reading the system information message over the BCCH for the suspended S-NSSAI(s) or misbehaving UEs which disrespect the system information message over the BCCH for the suspended S-NSSAI(s).

In another example, the RAN Node rejects the RRC Setup Complete message from the UE if the RRC Setup Complete message includes one or some S-NSSAI(s) that is subject for the suspension for service access. The one or some S-NSSAI(s) that is subject for the suspension for service access may be called as the suspended S-NSSAI(s). This can be happen for example, when the UE does not support reading the system information over the BCCH for the suspended S-NSSAI(s) or misbehaving UEs which disrespect the system information over the BCCH for the suspended S-NSSAI(s).

For example, when the RAN Node receives the RRC Setup Complete message from the UE, the RAN Node determines whether S-NSSAI(s) included in the RRC Setup Complete message is included in the suspended S-NSSAI(s) received from the AMF. If the S-NSSAI(s) in the RRC Setup Complete message is included in the suspended S-NSSAI(s), the RAN node may reject the RRC Setup Complete message.

### <Aspect 4—URSP Rules Tuning Based on the PDU Sessions Per Network Slice Status>

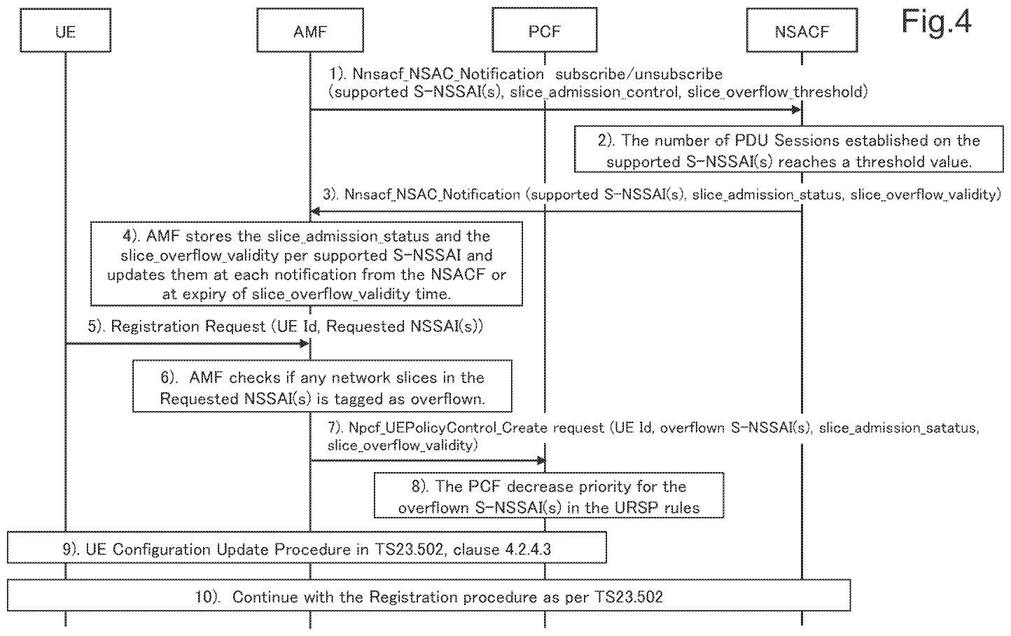

In the Aspect 4, the AMF subscribes with the NSACF for notification. The NSACF sends the notification to the AMF when the number of the PDU Sessions established on supported network slice(s) subject to NSAC reaches or exceeds a threshold value. The threshold value is, for example, the maximum number of the PDU Sessions allowed to be established on the network slice(s) or a certain percentage of the maximum number. When the AMF receives, from the NSACF, such notification for network slice(s), the AMF stores the network slice(s) and tags them as overflown (or overloaded or not available for access or any other notation to indicate that the network slice reaches or exceeds its maximum number of established PDU Sessions) until another notification from the NSACF that indicates the network slice(s) become available again (or not overflown or not overloaded) or until expiry of the slice_overflow_validity time, if the slice_overflow_validity time is provided by the NSACF in the slice_overflow_validity parameter. When a UE triggers Registration Request with the AMF, the AMF checks if any network slice(s) in the Requested NSSAI of the Registration Request message by the UE are tagged as overflown in the AMF. If one or more network slices from the Requested NSSAI(s) are found by the AMF to be overflown, the AMF forwards these overflown network slices to the PCF and the PCF updates the URSP rules for the UE so that the overflown S-NSSAI(s) is with lowest possible priority for selecting by the applications in the UE. The updated URSP rules are provided to the UE via the UE Configuration Update procedure. FIG. 4 shows detailed processes.

1). The AMF subscribes with a NSACF for notification. The AMF sends Nnsacf_NSAC_Notification subscribe message to the NSACF (Network Slice Admission Control Function) to subscribe for notifications. The Nnsacf_NSAC_Notification subscribe message indicates, for example, the AMF requests the NSACF to monitor the number of the PDU Sessions established on each one of the supported network slices.

The AMF includes, in Nnsacf_NSAC_Notification subscribe message, as parameters, one or more supported S-NSSAI(s) that is subject to NSAC, slice_admission_control parameter or any other notation for a parameter to indicate that the required notification is about the number of the PDU Sessions on each of the indicated network slices and slice_overflow_threshold parameter or any other notation for a parameter defining the threshold for triggering the notification from the NSACF.

The supported S-NSSAI(s) may indicate the supported network slice(s) which the AMF requests notification for.

The slice_admission_control parameter may be any other notation for a parameter to indicate that the required notification is about the number of the PDU Sessions on each of the indicated network slices. The slice_admission_control parameter may be information to indicate that the required notification is about the number of the PDU Sessions on each of the indicated network slices.

The slice_overflow_threshold parameter may be any other notation for a parameter defining the threshold value for triggering the notification from the NSACF. The slice_overflow_threshold parameter may be information defining the threshold value for triggering the notification from the NSACF.

Alternatively, the slice_overflow_threshold parameter may be configured in the NSACF by the operator based on the operator's policy or provided to the NSACF from the UDM or the O&M (Operation and Maintenance). The slice_overflow_threshold parameter may be equal to the maximum number of PDU Sessions allowed to be established on the network slice. The slice_overflow_threshold parameter may be a percentage representation of the maximum number of the PDU Sessions allowed on the network slice. The slice_overflow_threshold parameter may be applicable to all network slices supported by the AMF (e.g. same threshold for all the network slices) or per a specific network slice only (e.g. each network slice may have different threshold).

The NSACF may send the acknowledgement to the AMF in response to the Nnsacf_NSAC_Notification subscribe message from the AMF. The AMF may send, to the NSACF, a message to unsubscribe the notifications. The message may be an Nnsacf_NSAC_Notification unsubscribe message. The Nnsacf_NSAC_Notification unsubscribe message may include the same parameters as the Nnsacf_NSAC_Notification subscribe message, i.e., supported S-NSSAI(s), slice_admission_control parameter and slice_overflow_threshold parameter.

2) The NSACF monitors the number of the PDU Sessions established on each one of the supported network slices which the AMF requests notification for. When the number of the PDU Session on one or more of the monitored network slice(s) reaches or exceeds the threshold value based on the slice_overflow_threshold parameter for that network slice(s), the NSACF triggers notification to the AMF. The threshold value is, for example, the maximum number of the PDU Sessions allowed to be established on the network slice or a certain percentage of the maximum number. The notification may be an Nnsacf_NSAC_Notification.

Similarly, when the number of the PDU Sessions on one or more of the monitored network slices reaches or exceeds the threshold value once but starts decreasing and becomes less than the threshold value, the NSACF triggers notification to the AMF.

The slice_overflow_threshold parameter may alternatively be configured in the NSACF as well or provided in the NSACF from the UDM or the O&M.

3) After receiving the Nnsacf_NSAC_Notification subscribe message, the NSACF is configured to send, to the AMF, a notification when the number of the PDU Sessions established on a network slice supported by the AMF reaches or exceeds a certain threshold value. The threshold value is, for example, the maximum number of the PDU Sessions allowed to be established on the network slice or a certain percentage of the maximum number. The NSACF sends Nnsacf_NSAC_Notification message to the AMF. The NSACF includes, in Nnsacf_NSAC_Notification message, parameters described below:
the supported S-NSSAI(s) indicating the supported network slice(s) which the AMF requests notification for;
the slice_admission_status parameter which indicates whether the corresponding supported network slice is overflown. The slice_admission_status parameter is a parameter per supported network slice. The ‘overflown’ may be any other notation, e.g. overloaded or not available for access, and the ‘not overflown’ may be another notation e.g. not overloaded or available for access. The NSACF returns ‘overflown’ value in the slice_admission_status parameter if the number of the PDU Sessions on the supported network slice reaches or exceeds the threshold value provided in the slice_overflow_threshold parameter. The NSACF returns ‘not overflown’ value in the slice_admission_status' parameter if the number of the PDU Sessions on the supported network slice remains under the threshold value, or reaches or exceeds the threshold value once but starts decreasing and becomes less than the threshold value provided in the slice_overflow_threshold parameter;
the slice_overflow_validity parameter which is an optional parameter. When the NSACF notifies ‘overflown’ value in the slice_admission_status parameter, the NSACF may also include a slice_overflow_validity parameter which defines slice_overflow_validity time for how long the network slice is overflown. The slice_overflow_validity parameter is a parameter per network slice which is overflown.

For example, when the number of the established PDU Sessions on a network slice indicated by S-NSSAI-1 as the supported S-NSSAI, reaches or exceeds the threshold value, the NSACF may send, to the AMF, the Nnsacf_NSAC_Notification message including the S-NSSAI-1 as the supported S-NSSAI, the slice_admission_status parameter which is set to ‘overflown’ value indicating that the network slice indicated by the S-NSSAI-1 is overflown, and the slice_overflow_validity parameter indicating how long the network slice indicated by the S-NSSAI-1 is overflown.

For example, when the number of the established PDU Sessions on a network slice indicated by S-NSSAI-1 as the supported S-NSSAI reaches or exceeds the threshold value once but starts decreasing and becomes less than the threshold value, the NSACF may send, to the AMF, the Nnsacf_NSAC_Notification message including the S-NSSAI-1 as the supported S-NSSAI and the slice_admission_status parameter which is set to ‘not overflown’ value indicating that a network slice indicated by the S-NSSAI-1 is not overflown.

4) The AMF stores overflown network slice(s) notified by the NSACF. The overflown network slice(s) may be the supported S-NSSAI(s) with the ‘overflown’ value set in the latest slice_admission_status parameter reported in the Nnsacf_NSAC_Notification message from the NSACF. The AMF may manage or maintain a list of the supported network slice(s) for storing the overflown network slice(s) notified by the NSACF. In the list of the supported network slice(s), each network slice is tagged as ‘overflown’ or ‘not overflown’ based on the latest slice_admission_status parameter in the Nnsacf_NSAC_Notification message from the NSACF. The list of the supported network slice(s) may be a list of the supported S-NSSAI(s). The list of the supported network slice(s) may include only a list of the overflown network slice(s) tagged as ‘overflown’ based on the latest slice_admission_status parameter.

If the NSACF provides the slice_overflow_validity parameter, at expiry of the slice_overflow_validity time for how long the network slice is over flown defined by the slice_overflow_validity parameter the AMF updates the tag of the related network slice from ‘overflown’ to ‘not overflown’ or removes the related network slice from the list of the overflown network slices tagged as ‘overflown’. In this way, the AMF maintains a list of S-NSSAI(s) that is overflown along with their slice_overflow_validity time based on the slice_overflow_validity parameter. The list of S-NSSAI(s) that is overflown may be a list of network slice(s) that is overflown. The AMF may use a timer to determine the expiry of the slice_overflow_validity time. The list of S-NSSAI(s) that is overflown may be a list of S-NSSAI(s) tagged with ‘overflown’. For example, if S-NSSAI-1 and S-NSSAI-2 are overflown, the list includes S-NSSAI-1 tagged as ‘overflown’ and S-NSSAI-2 tagged as ‘overflown’.

The list of S-NSSAI(s) or the list of S-NSSAI(s) that is overflown may be called as a list of the overflown network slices or the list of the network slices tagged as ‘overflown’. The list of S-NSSAI(s) that is overflown may be called as a list of the overflown S-NSSAI(s).

The AMF stores the slice admission status and the slice_overflow_validity per supported S-NSSAI and updates them at each notification from the NSACF or at expiry of the slice_overflow_validity time. For example, the AMF may store or maintain the list in a same manner as the step 4 in Aspect 1.

5) A UE initiates a registration procedure by sending the Registration Request message to the AMF. The Registration Request message may include UE Id and Requested NSSAI(s).

6) The AMF checks if any network slices (e.g. S-NSSAI(s)) in the Requested NSSAI(s) of the Registration Request message is in the list of the network slices (e.g. S-NSSAI(s)) tagged as ‘overflown’.

7) If any network slices in the Requested NSSAI(s) of the Registration Request message is found to be in the list of the overflown S-NSSAI(s) in the AMF, the AMF forwards these network slices to the PCF in the Npcf_UEPolicyControl_Create request message. The Npcf_UEPolicyControl_Create request message includes UE Id (e.g. SUPI), overflown S-NSSAI(s), and the slice_admission_status parameter. The AMF also includes the slice_overflow_validity parameter, if available. The overflown S-NSSAI(s) may indicate overflown network slice(s). The overflown S-NSSAI(s) may indicate S-NSSAI(s) related to overflown network slice(s).

The PCF may send a Npcf_UEPolicyControl_Create response message to the AMF in response to the Npcf_UEPolicyControl_Create request message.

8) If the PCF receives overflown network slices (e.g. overflown S-NSSAI(s)) within the Npcf_UEPolicyControl_Create request message, the PCF updates the URSP (or the URSP rules) for the UE that is being registered for the overflown network slice. The PCF decreases priority for the overflown network slice(s) by making the overflown network slice the least desirable network slice in the NSSP (Network Slice Selection Policy) rules which defines which Application what network slice to use in priority order list of network slices. If the PCF received the slice_overflow_validity parameter for the overflown network slice, the PCF restores back the networks slice priority for the overflown network slice in the URSP rules at expiry of the slice_overflow_validity time indicated by the slice_overflow_validity parameter.

For example, if the NSSP rules within the URSP rules are mapping the service requiring Application with several network slices, e.g. S-NSSAI-1, S-NSSAI-2, S-NSSAI-3 in this order (i.e. the NSSP rules indicate that S-NSSAI-1 has highest priority for the Application) and a network slice indicated by the S-NSSAI-1 is overflown, then the PCF may modify or update the NSSP rules so as to include S-NSSAI-2, S-NSSAI-3, S-NSSAI-1 in this order.

9) The PCF uses the UE Configuration Update Procedure in NPL 3, clause 4.2.4.3 to deliver to the UE the updated URSP rules including the updated NSSP rules.

10) The Registration procedure continues as per NPL 3.

In Aspects 1, 2 and 4, the number of UEs registered on a network slice may be used instead of the number of PDU sessions on the network slice. For example, in Aspects 1, 2 and 4, the NSACF may monitor the number of UEs registered on a network slice.

This disclosure in the above aspects addresses a problem identified in the new Release 18 study proposal on network slices in NPL 5 in 3GPP SA2 Working Group, i.e. how to define a mechanism for allocating the most suitable network slice to the UE or UE's PDU session in certain scenarios if a requested network slice from the UE is not allowed due to the Network Slice Admission Control.

### <System Overview>

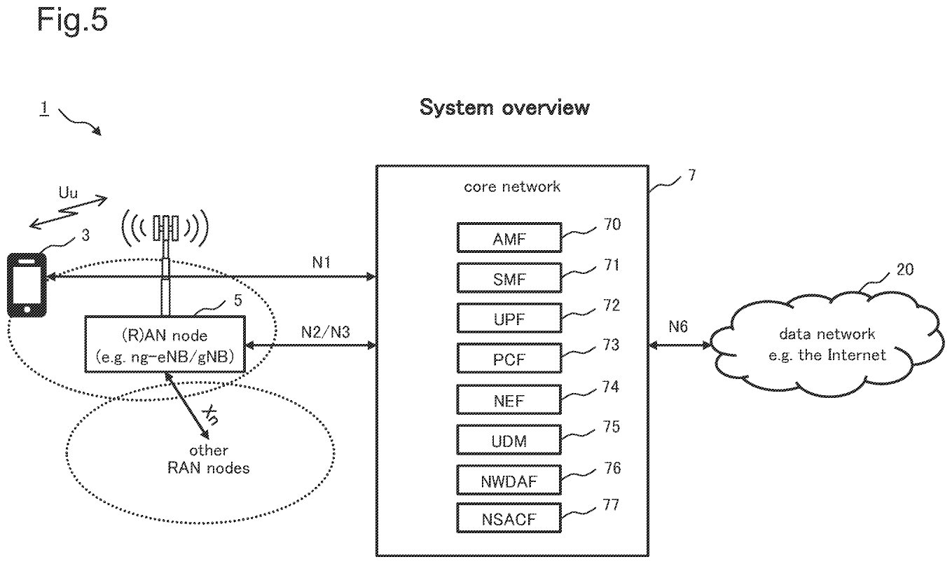

FIG. 5 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions.

Each function in a logical node can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Data Analytics Function (NWDAF) 76 and Network Slice Admission Control Function (NSACF) 77. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“NY” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC Setup Complete message: This message is sent from the UE 3 to the (R)AN node 5. In addition to the parameters that are disclosed by Aspects in this disclosure, following parameters may be included together in the RRC Setup Complete message.
   guami-Type, iab-NodeIndication, idleMeasAvailable, mobilityState, ng-5G-S-TMSI—Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, following parameters may be included together in the Registration Request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI,ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### <User Equipment (UE)>

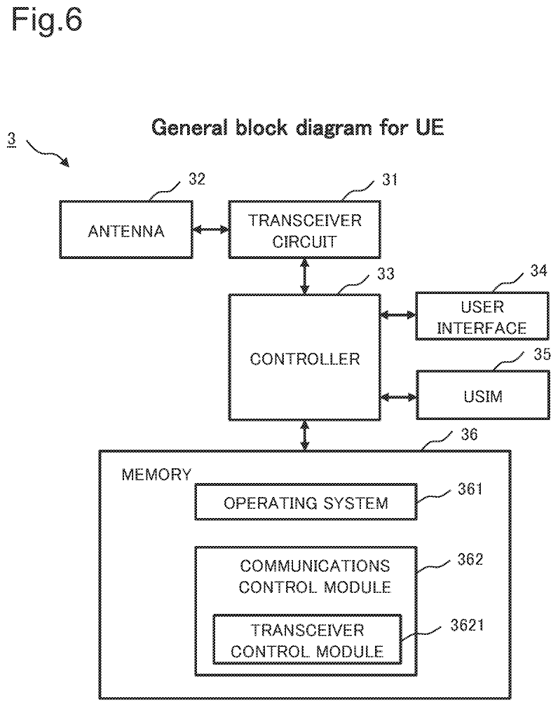

FIG. 6 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.). The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

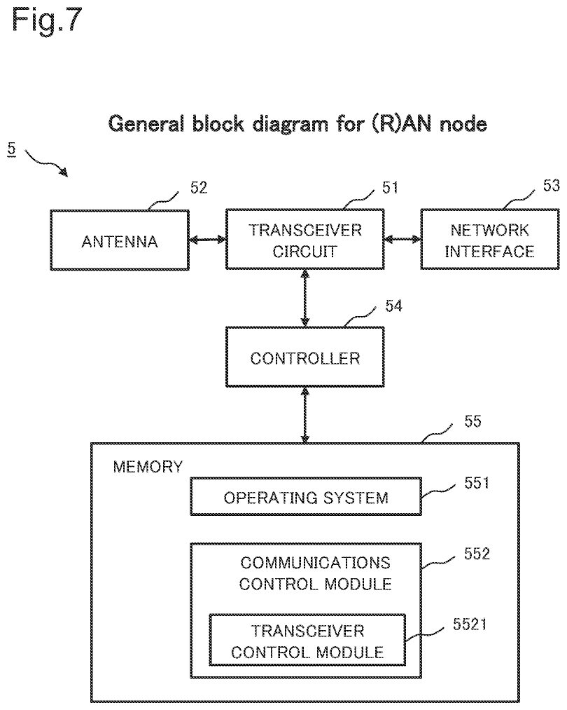

FIG. 7 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

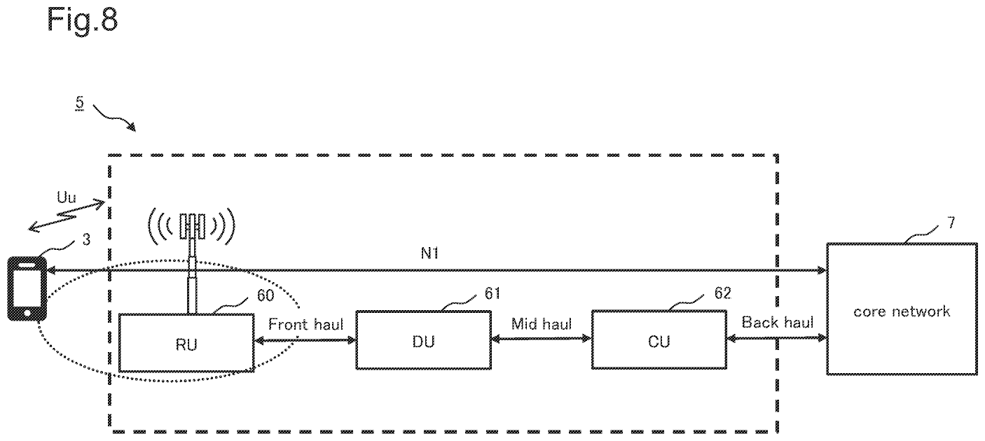

FIG. 8 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

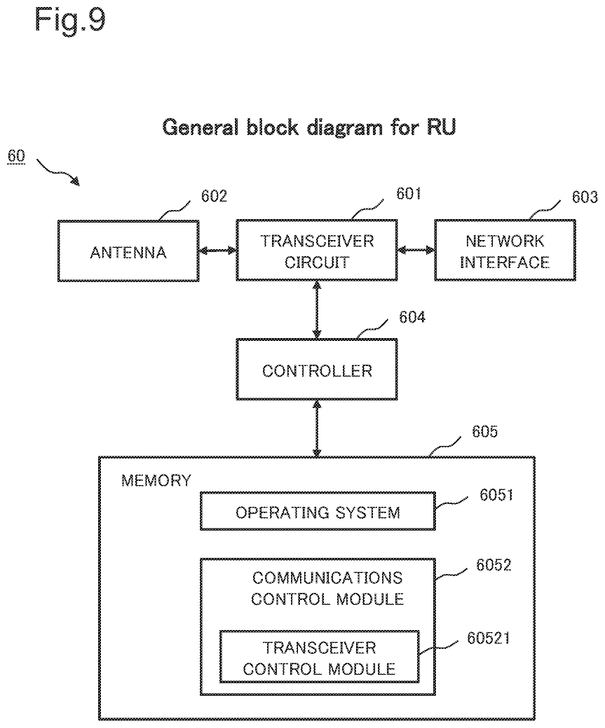

FIG. 9 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly).

The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

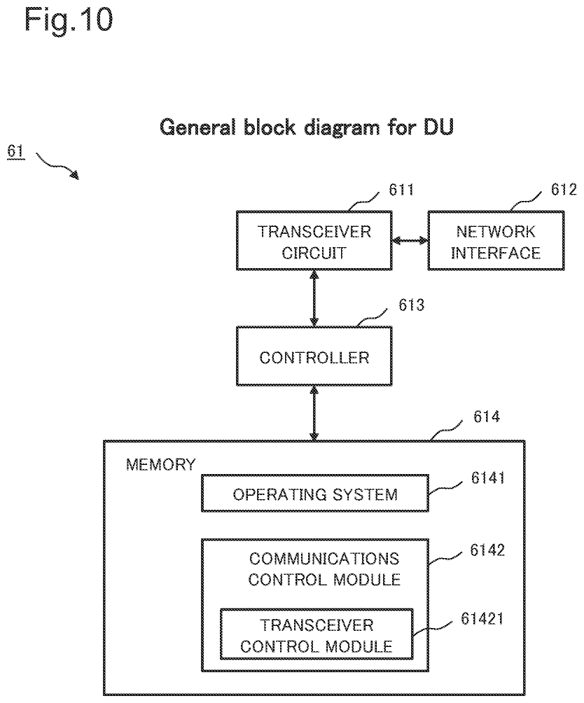

FIG. 10 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

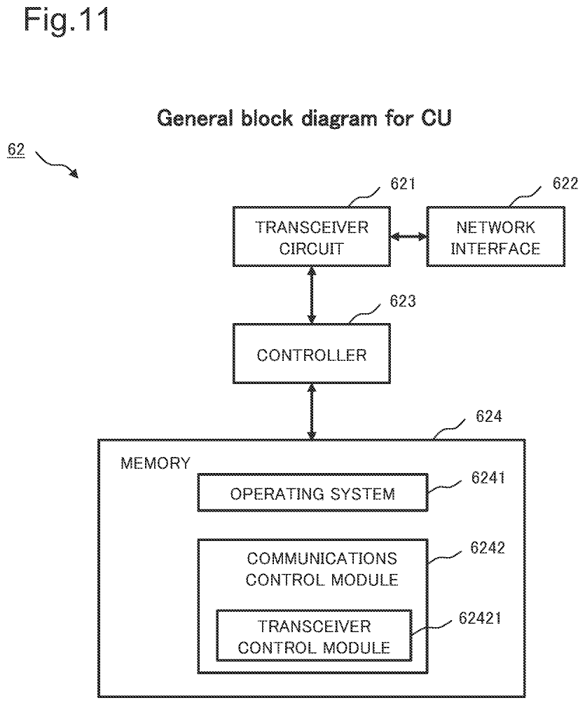

FIG. 11 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

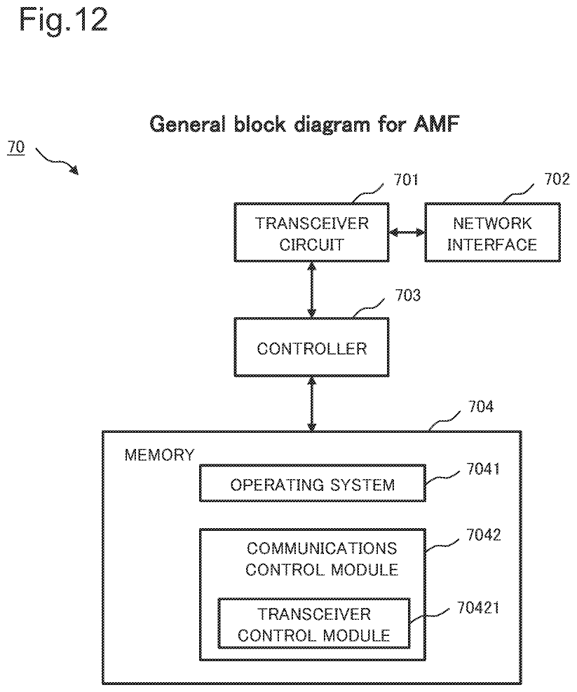

FIG. 12 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

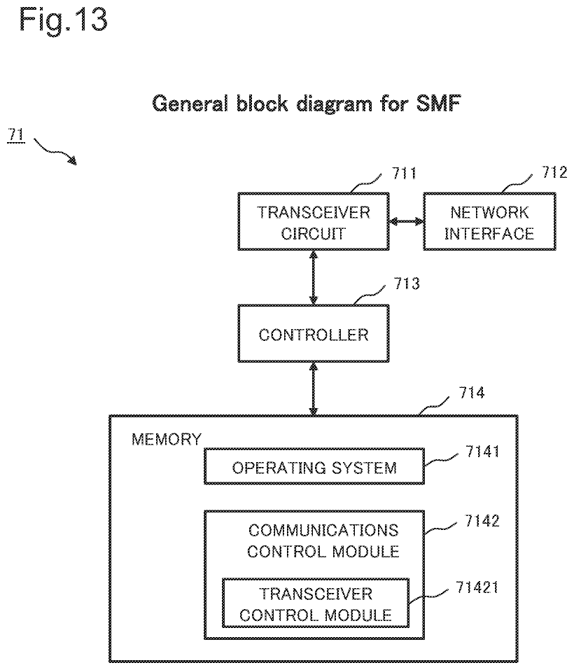

FIG. 13 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable data storage device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <PCF>

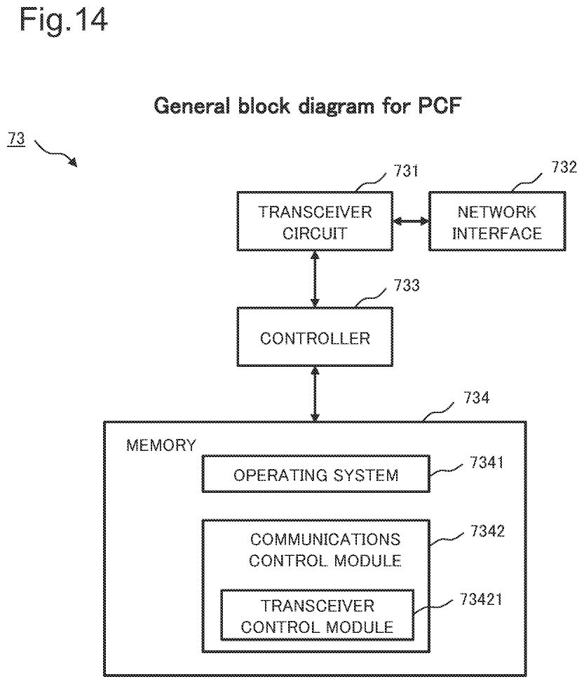

FIG. 14 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (RMD), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <UDM>

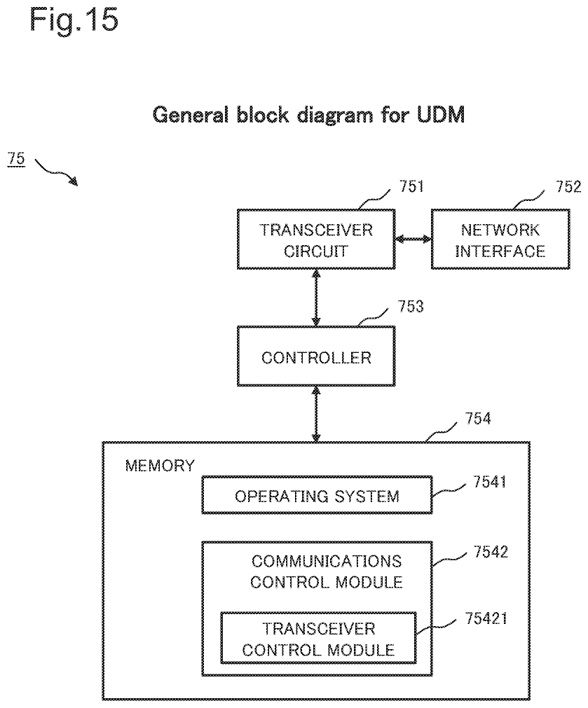

FIG. 15 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NSACF>

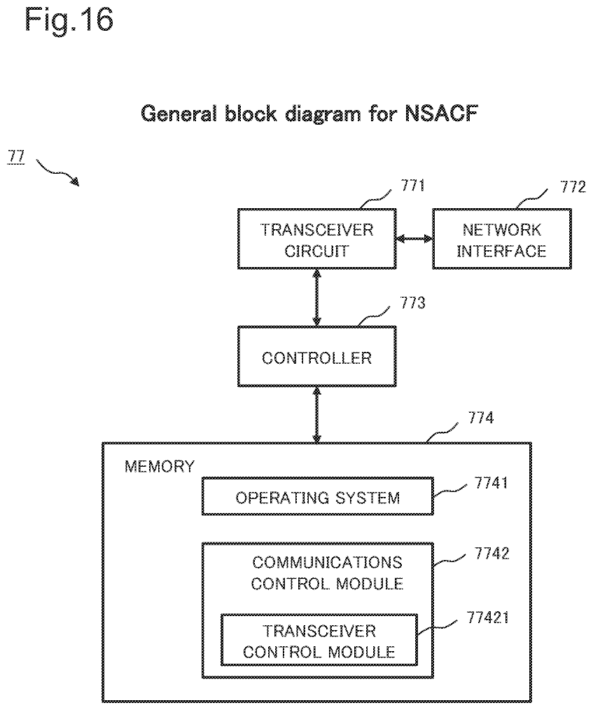

FIG. 16 is a block diagram illustrating the main components of the NSACF 77. As shown, the apparatus includes a transceiver circuit 771 which is operable to transmit signals to and to receive signals from other nodes (including the AMF 70) via a network interface 772. A controller 773 controls the operation of the NSACF 77 in accordance with the software stored in a memory 774. The Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSACF 77 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NSACF 77 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS.

The whole or part of the example Aspects disclosed above can be described as, but not limited to, the following supplementary notes.

supplementary note 1. A method of an Access and Mobility management Function (AMF) apparatus, the method comprising: receiving, from a Network Slice Admission Control Function (NSACF) apparatus, first information related to an overflown network slice;
receiving, from a User Equipment (UE), second information related to a first network slice and third information related to a second network slice;
determining whether the first network slice is overflown based on the first information;
determining whether the second network slice is overflown based on the first information; and
sending, to a Session Management Function (SMF) apparatus, the third information to establish a Protocol Data Unit (PDU) session on the second network slice in a case where the first network slice is overflown and the second network slice is not overflown.

supplementary note 2. The method according to supplementary note 1, further comprising:
sending a predetermined threshold value and a request to monitor whether the number of established PDU sessions of the first network slice reaches the predetermined threshold value,
wherein the first information is received in a case where the number of established PDU sessions of the first network slice reaches the predetermined threshold value.

supplementary note 3. The method according to supplementary note 1 or 2, further comprising:
receiving a time value from the NSACF apparatus; and
determining that the first network slice is not overflown in case of expiry of the time value.

supplementary note 4. The method according to any one of supplementary notes 1 to 3, further comprising:
receiving, from the UE, priority information indicating that the second network slice has priority; and
sending, to the SMF apparatus, the third information to establish the PDU session on the second network slice in a case where the AMF receives the priority information and the second network slice is overflown.

supplementary note 5. A method of a User Equipment (UE), the method comprising:
communicating with an Access and Mobility management Function (AMF) apparatus; and
sending, to the AMF apparatus, first information related to a first network slice and second information related to a second network slice,
wherein a Protocol Data Unit (PDU) session is established on the second network slice instead of the first network slice in a case where the first network slice is overflown.

supplementary note 6. The method according to supplementary note 5, further comprising:
sending, to the AMF apparatus, priority information indicating that the second network slice has priority,
wherein the PDU session is established on the second network slice in a case where the priority information is sent and the second network slice is overflown.

supplementary note 7. A method of a Network Slice Admission Control Function (NSACF) apparatus, the method comprising:
receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value;
monitoring whether the first number or the second number reaches the predetermined threshold value; and
sending, to the AMF apparatus, a notification indicating that the first number or the second number reaches the predetermined threshold value in a case where the first number or the second number reaches the predetermined threshold value.

supplementary note 8. The method according to supplementary note 7, further comprising:
sending, to the AMF apparatus, a time value indicating how long the first network slice is overflown.

supplementary note 9. A method of an Access and Mobility management Function (AMF) apparatus, the method comprising:
receiving, from a Network Slice Admission Control Function (NSACF) apparatus, first information related to an overflown network slice;
receiving, from a User Equipment (UE), second information related to a first network slice;
determining whether the first network slice is overflown based on the first information;
sending, to the UE, third information related to a second network slice in a case where the first network slice is overflown; and
receiving, from the UE, a message to establish a Protocol Data Unit (PDU) session on the second network slice,
wherein the message includes the third information.

supplementary note 10. The method according to supplementary note 9, further comprising:
sending, to the UE, a reject cause value indicating that PDU session establishment on the first network slice is rejected due to an overflow of the first network slice in a case where the first network slice is overflown.

supplementary note 11. A method of a User Equipment (UE), the method comprising:
sending, to an Access and Mobility management Function (AMF) apparatus, first information related to a first network slice;
receiving, from the AMF apparatus, second information related to a second network slice in a case where the first network slice is overflown; and
sending, to the AMF apparatus, a message to establish a Protocol Data Unit (PDU) session on the second network slice,
wherein the message includes the second information.

supplementary note 12. The method according to supplementary note 11, further comprising:
receiving, from the AMF apparatus, a reject cause value indicating that PDU session establishment on the first network slice is rejected due to an overflow of the first network slice in a case where the first network slice is overflown.
supplementary note 13. A method of an Access and Mobility management Function (AMF) apparatus, the method comprising:
receiving, from a Network Slice Admission Control Function (NSACF) apparatus, first information related to an overflown network slice; and
sending, to a Radio Access Network (RAN) Node, the first information and second information indicating that the overflown network slice is suspended for registration or service.
supplementary note 14. A method of a Radio Access Network (RAN) Node, the method comprising:
receiving, from an Access and Mobility management Function (AMF) apparatus, first information related to an overflown network slice and second information indicating that the overflown network slice is suspended for registration or service; and
stopping broadcasting the first information.

supplementary note 15. A method of a Radio Access Network (RAN) Node, the method comprising:
receiving, from an Access and Mobility management Function (AMF) apparatus, first information related to an overflown network slice and second information indicating that the overflown network slice is suspended for registration or service; and
broadcasting the first information in information element indicating a network slice suspended for the registration or the service.

supplementary note 16. A method of an Access and Mobility management Function (AMF) apparatus, the method comprising:
receiving, from a Network Slice Admission Control Function (NSACF) apparatus, first information related to an overflown network slice;
receiving, from a User Equipment (UE), second information related to a first network slice;
determining whether the first network slice is overflown based on the first information; and
sending, to a Policy Control Function (PCF) apparatus, the second information to modify a Network Slice Selection Policy (NSSP) related to the first network slice in a case where the first network slice is overflown.

supplementary note 17. A method of a Policy Control Function (PCF) apparatus, the method comprising:
receiving, from an Access and Mobility management Function (AMF) apparatus, information related to an overflown network slice; and
modifying a Network Slice Selection Policy (NSSP) related to the overflown network slice based on the information.

supplementary note 18. An Access and Mobility management Function (AMF) apparatus comprising:
means for receiving, from a Network Slice Admission Control Function (NSACF) apparatus, first information related to an overflown network slice;
means for receiving, from a User Equipment (UE), second information related to a first network slice and third information related to a second network slice;
means for determining whether the first network slice is overflown based on the first information;
means for determining whether the second network slice is overflown based on the first information; and
means for sending, to a Session Management Function (SMF) apparatus, the third information to establish a Protocol Data Unit (PDU) session on the second network slice in a case where the first network slice is overflown and the second network slice is not overflown.

supplementary note 19. The AMF apparatus according to supplementary note 18, further comprising:
means for sending a predetermined threshold value and a request to monitor whether the number of established PDU sessions of the first network slice reaches the predetermined threshold value,
wherein the first information is received in a case where the number of established PDU sessions of the first network slice reaches the predetermined threshold value.

supplementary note 20. The AMF apparatus according to supplementary note 18 or 19, further comprising:
means for receiving a time value from the NSACF apparatus; and
means for determining that the first network slice is not overflown in case of expiry of the time value.

supplementary note 21. The AMF apparatus according to any one of supplementary notes 18 to 20, further comprising:
means for receiving, from the UE, priority information indicating that the second network slice has priority; and
means for sending, to the SMF apparatus, the third information to establish the PDU session on the second network slice in a case where the AMF receives the priority information and the second network slice is overflown.

supplementary note 22. A User Equipment (UE) comprising:
means for communicating with an Access and Mobility management Function (AMF) apparatus; and
means for sending, to the AMF apparatus, first information related to a first network slice and second information related to a second network slice,
wherein a Protocol Data Unit (PDU) session is established on the second network slice instead of the first network slice in a case where the first network slice is overflown.

supplementary note 23. The UE according to supplementary note 22, further comprising:
means for sending, to the AMF apparatus, priority information indicating that the second network slice has priority,
wherein the PDU session is established on the second network slice in a case where the priority information is sent and the second network slice is overflown.

supplementary note 24. A Network Slice Admission Control Function (NSACF) apparatus comprising:
means for receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value;
means for monitoring whether the first number or the second number reaches the predetermined threshold value; and
means for sending, to the AMF apparatus, a notification indicating that the first number or the second number reaches the predetermined threshold value in a case where the first number or the second number reaches the predetermined threshold value.

supplementary note 25. The NSACF apparatus according to supplementary note 24, further comprising:
means for sending, to the AMF apparatus, a time value indicating how long the first network slice is overflown.

supplementary note 26. An Access and Mobility management Function (AMF) apparatus comprising:
means for receiving, from a Network Slice Admission Control Function (NSACF) apparatus, first information related to an overflown network slice;
means for receiving, from a User Equipment (UE), second information related to a first network slice;
means for determining whether the first network slice is overflown based on the first information;
means for sending, to the UE, third information related to a second network slice in a case where the first network slice is overflown; and
means for receiving, from the UE, a message to establish a Protocol Data Unit (PDU) session on the second network slice, wherein the message includes the third information.

supplementary note 27. The AMF apparatus according to supplementary note 26, further comprising:
means for sending, to the UE, a reject cause value indicating that PDU session establishment on the first network slice is rejected due to an overflow of the first network slice in a case where the first network slice is overflown.

supplementary note 28. A User Equipment (UE) comprising:
means for sending, to an Access and Mobility management Function (AMF) apparatus, first information related to a first network slice;
means for receiving, from the AMF apparatus, second information related to a second network slice in a case where the first network slice is overflown; and
means for sending, to the AMF apparatus, a message to establish a Protocol Data Unit (PDU) session on the second network slice,
wherein the message includes the second information.

supplementary note 29. The UE according to supplementary note 28, further comprising:
means for receiving, from the AMF apparatus, a reject cause value indicating that PDU session establishment on the first network slice is rejected due to an overflow of the first network slice in a case where the first network slice is overflown.

supplementary note 30. An Access and Mobility management Function (AMF) apparatus comprising:
means for receiving, from a Network Slice Admission Control Function (NSACF) apparatus, first information related to an overflown network slice; and
means for sending, to a Radio Access Network (RAN) Node, the first information and second information indicating that the overflown network slice is suspended for registration or service.

supplementary note 31. A Radio Access Network (RAN) Node comprising:
means for receiving, from an Access and Mobility management Function (AMF) apparatus, first information related to an overflown network slice and second information indicating that the overflown network slice is suspended for registration or service; and
means for stopping broadcasting the first information.

supplementary note 32. A Radio Access Network (RAN) Node comprising:
means for receiving, from an Access and Mobility management Function (AMF) apparatus, first information related to an overflown network slice and second information indicating that the overflown network slice is suspended for registration or service; and
means for broadcasting the first information in information element indicating a network slice suspended for the registration or the service.

supplementary note 33. An Access and Mobility management Function (AMF) apparatus comprising:
means for receiving, from a Network Slice Admission Control Function (NSACF) apparatus, first information related to an overflown network slice;
means for receiving, from a User Equipment (UE), second information related to a first network slice;
means for determining whether the first network slice is overflown based on the first information; and
means for sending, to a Policy Control Function (PCF) apparatus, the second information to modify a Network Slice Selection Policy (NSSP) related to the first network slice in a case where the first network slice is overflown.

supplementary note 34. A Policy Control Function (PCF) apparatus comprising:
means for receiving, from an Access and Mobility management Function (AMF) apparatus, information related to an overflown network slice; and
means for modifying a Network Slice Selection Policy (NSSP) related to the overflown network slice based on the information.

supplementary note 35. A method of an Access and Mobility management Function (AMF) apparatus, the method comprising:
receiving, from a User Equipment (UE), first information related to a first network slice and second information related to a second network slice; and
sending, to a Session Management Function (SMF) apparatus, the second information to establish a Protocol Data Unit (PDU) session on the second network slice in a case where the first network slice is overloaded.

supplementary note 36. The method according to supplementary note 35,
wherein the sending the second information includes sending, to the SMF apparatus, the second information to establish the PDU session on the second network slice in a case where the first network slice is overloaded before establishing a PDU session on the first network slice.

supplementary note 37. The method according to supplementary note 35 or 36, further comprising:
determining whether the first network slice is overloaded.
supplementary note 38. The method according to supplementary note 37, further comprising:
receiving, from a Network Slice Admission Control Function (NSACF) apparatus, third information related to an overloaded network slice,
wherein the determining whether the first network slice is overloaded includes determining whether the first network slice is overloaded based on the third information.

supplementary note 39. The method according to supplementary note 38, further comprising:
determining whether the second network slice is overloaded based on the third information,
wherein the sending the second information includes sending the second information in a case where the first network slice is overloaded and the second network slice is not overloaded.

supplementary note 40. The method according to supplementary note 38 or 39, further comprising:
sending a predetermined threshold value and a request to monitor whether the number of established PDU sessions of the first network slice reaches the predetermined threshold value,
wherein the third information is received in a case where the number of established PDU sessions of the first network slice reaches the predetermined threshold value.

supplementary note 41. The method according to any one of supplementary notes 38 to 40, further comprising:
receiving a time value from the NSACF apparatus; and
determining that the first network slice is not overloaded in case of expiry of the time value.

supplementary note 42. The method according to any one of supplementary notes 35 to 41, further comprising:
receiving, from the UE, priority information indicating that the second network slice has priority; and
sending, to the SMF apparatus, the second information to establish the PDU session on the second network slice in a case where the AMF apparatus receives the priority information and the second network slice is overloaded.

supplementary note 43. The method according to any one of supplementary notes 35 to 42,
wherein the second information is Compatible Single Network Slice Selection Assistance Information (S-NSSAI).

supplementary note 44. The method according to any one of supplementary notes 35 to 42,
wherein the second information is additional Single Network Slice Selection Assistance Information (S-NSSAI).

supplementary note 45. The method according to any one of supplementary notes 35 to 44,
wherein the second network slice is a compatible network slice.

supplementary note 46. A method of a User Equipment (UE), the method comprising:
communicating with an Access and Mobility management Function (AMF) apparatus; and
sending, to the AMF apparatus, first information related to a first network slice and second information related to a second network slice,
wherein a Protocol Data Unit (PDU) session is established on the second network slice instead of the first network slice in a case where the first network slice is overloaded.

supplementary note 47. The method according to supplementary note 46, further comprising:
sending, to the AMF apparatus, priority information indicating that the second network slice has priority,
wherein the PDU session is established on the second network slice in a case where the priority information is sent and the second network slice is overloaded.

supplementary note 48. The method according to supplementary note 46 or 47,
wherein the PDU session is established on the second network slice instead of the first network slice in a case where the first network slice is overloaded before establishing a PDU session on the first network slice.

supplementary note 49. The method according to any one of supplementary notes 46 to 48,
wherein the second information is Compatible Single Network Slice Selection Assistance Information (S-NSSAI).

supplementary note 50. The method according to any one of supplementary notes 46 to 48,
wherein the second information is additional Single Network Slice Selection Assistance Information (S-NSSAI).

supplementary note 51. The method according to any one of supplementary notes 46 to 50,
wherein the second network slice is a compatible network slice.

supplementary note 52. A method of a Network Slice Admission Control Function (NSACF) apparatus, the method comprising:
receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value;
monitoring whether the first number or the second number reaches the predetermined threshold value; and
sending, to the AMF apparatus, a notification indicating that the first number or the second number reaches the predetermined threshold value in a case where the first number or the second number reaches the predetermined threshold value.

supplementary note 53. The method according to supplementary note 52, further comprising:
sending, to the AMF apparatus, a time value indicating how long the first network slice is overloaded.

supplementary note 54. A method of an Access and Mobility management Function (AMF) apparatus, the method comprising:
receiving, from a Network Slice Admission Control Function (NSACF) apparatus, first information related to an overloaded network slice;
receiving, from a User Equipment (UE), second information related to a first network slice;
determining whether the first network slice is overloaded based on the first information;
sending, to the UE, third information related to a second network slice in a case where the first network slice is overloaded; and
receiving, from the UE, a message to establish a Protocol Data Unit (PDU) session on the second network slice,
wherein the message includes the third information.

supplementary note 55. The method according to supplementary note 54, further comprising:
sending, to the UE, a reject cause value indicating that PDU session establishment on the first network slice is rejected due to an overload of the first network slice in a case where the first network slice is overloaded.

supplementary note 56. A method of a User Equipment (UE), the method comprising:
sending, to an Access and Mobility management Function (AMF) apparatus, first information related to a first network slice;
receiving, from the AMF apparatus, second information related to a second network slice in a case where the first network slice is overloaded; and
sending, to the AMF apparatus, a message to establish a Protocol Data Unit (PDU) session on the second network slice,
wherein the message includes the second information.

supplementary note 57. The method according to supplementary note 56, further comprising:
receiving, from the AMF apparatus, a reject cause value indicating that PDU session establishment on the first network slice is rejected due to an overload of the first network slice in a case where the first network slice is overloaded.

supplementary note 58. A method of an Access and Mobility management Function (AMF) apparatus, the method comprising:
receiving, from a Network Slice Admission Control Function (NSACF) apparatus, first information related to an overloaded network slice; and
sending, to a Radio Access Network (RAN) Node, the first information and second information indicating that the overloaded network slice is suspended for registration or service.

supplementary note 59. A method of a Radio Access Network (RAN) Node, the method comprising:
receiving, from an Access and Mobility management Function (AMF) apparatus, first information related to an overloaded network slice and second information indicating that the overloaded network slice is suspended for registration or service; and
stopping broadcasting the first information.

supplementary note 60. A method of a Radio Access Network (RAN) Node, the method comprising:
receiving, from an Access and Mobility management Function (AMF) apparatus, first information related to an overloaded network slice and second information indicating that the overloaded network slice is suspended for registration or service; and
broadcasting the first information in information element indicating a network slice suspended for the registration or the service.

supplementary note 61. A method of an Access and Mobility management Function (AMF) apparatus, the method comprising:
receiving, from a Network Slice Admission Control Function (NSACF) apparatus, first information related to an overloaded network slice;
receiving, from a User Equipment (UE), second information related to a first network slice;
determining whether the first network slice is overloaded based on the first information; and
sending, to a Policy Control Function (PCF) apparatus, the second information to modify a Network Slice Selection Policy (NSSP) related to the first network slice in a case where the first network slice is overloaded.

supplementary note 62. A method of a Policy Control Function (PCF) apparatus, the method comprising:
receiving, from an Access and Mobility management Function (AMF) apparatus, information related to an overloaded network slice; and
modifying a Network Slice Selection Policy (NSSP) related to the overloaded network slice based on the information.

supplementary note 63. An Access and Mobility management Function (AMF) apparatus comprising:
means for receiving, from a User Equipment (UE), first information related to a first network slice and second information related to a second network slice; and
means for sending, to a Session Management Function (SMF) apparatus, the second information to establish a Protocol Data Unit (PDU) session on the second network slice in a case where the first network slice is overloaded.

supplementary note 64. The AMF apparatus according to supplementary note 63,
wherein the means for sending is configured to send, to the SMF apparatus, the second information to establish the PDU session on the second network slice in a case where the first network slice is overloaded before establishing a PDU session on the first network slice.

supplementary note 65. The AMF apparatus according to supplementary note 63 or 64, further comprising:
means for determining whether the first network slice is overloaded.

supplementary note 66. The AMF apparatus according to supplementary note 65, further comprising:
means for receiving, from a Network Slice Admission Control Function (NSACF) apparatus, third information related to an overloaded network slice,
wherein the means for determining is configured to determine whether the first network slice is overloaded based on the third information.

supplementary note 67. The AMF apparatus according to supplementary note 66, further comprising:
means for determining whether the second network slice is overloaded based on the third information,
wherein the means for sending is configured to send the second information in a case where the first network slice is overloaded and the second network slice is not overloaded.

supplementary note 68. The AMF apparatus according to supplementary note 66 or 67, further comprising:
means for sending a predetermined threshold value and a request to monitor whether the number of established PDU sessions of the first network slice reaches the predetermined threshold value,
wherein the third information is received in a case where the number of established PDU sessions of the first network slice reaches the predetermined threshold value.

supplementary note 69. The AMF apparatus according to any one of supplementary notes 66 to 68, further comprising:
means for receiving a time value from the NSACF apparatus; and
means for determining that the first network slice is not overloaded in case of expiry of the time value.

supplementary note 70. The AMF apparatus according to any one of supplementary notes 63 to 69, further comprising:
means for receiving, from the UE, priority information indicating that the second network slice has priority; and
means for sending, to the SMF apparatus, the second information to establish the PDU session on the second network slice in a case where the AMF apparatus receives the priority information and the second network slice is overloaded.

supplementary note 71. The AMF apparatus according to any one of supplementary notes 63 to 70,
wherein the second information is Compatible Single Network Slice Selection Assistance Information (S-NSSAI).

supplementary note 72. The AMF apparatus according to any one of supplementary notes 63 to 70,
wherein the second information is additional Single Network Slice Selection Assistance Information (S-NSSAI).

supplementary note 73. The AMF apparatus according to any one of supplementary notes 63 to 72,
wherein the second network slice is a compatible network slice.

supplementary note 74. A User Equipment (UE) comprising:
means for communicating with an Access and Mobility management Function (AMF) apparatus; and
means for sending, to the AMF apparatus, first information related to a first network slice and second information related to a second network slice,
wherein a Protocol Data Unit (PDU) session is established on the second network slice instead of the first network slice in a case where the first network slice is overloaded.

supplementary note 75. The UE according to supplementary note 74, further comprising:
means for sending, to the AMF apparatus, priority information indicating that the second network slice has priority,
wherein the PDU session is established on the second network slice in a case where the priority information is sent and the second network slice is overloaded.

supplementary note 76. The UE according to supplementary note 74 or 75,
wherein the PDU session is established on the second network slice instead of the first network slice in a case where the first network slice is overloaded before establishing a PDU session on the first network slice.

supplementary note 77. The UE according to any one of supplementary notes 74 to 76,
wherein the second information is Compatible Single Network Slice Selection Assistance Information (S-NSSAI).

supplementary note 78. The UE according to any one of supplementary notes 74 to 76,
wherein the second information is additional Single Network Slice Selection Assistance Information (S-NSSAI).

supplementary note 79. The UE according to any one of supplementary notes 74 to 78,
wherein the second network slice is a compatible network slice.

supplementary note 80. A Network Slice Admission Control Function (NSACF) apparatus comprising:
means for receiving, from an Access and Mobility management Function (AMF) apparatus, a predetermined threshold value and a request to monitor whether the first number of established PDU sessions of a first network slice or the second number of registered User Equipments of the first network slice reaches the predetermined threshold value;
means for monitoring whether the first number or the second number reaches the predetermined threshold value; and
means for sending, to the AMF apparatus, a notification indicating that the first number or the second number reaches the predetermined threshold value in a case where the first number or the second number reaches the predetermined threshold value.

supplementary note 81. The NSACF apparatus according to supplementary note 80, further comprising:
means for sending, to the AMF apparatus, a time value indicating how long the first network slice is overloaded.

supplementary note 82. An Access and Mobility management Function (AMF) apparatus comprising:
means for receiving, from a Network Slice Admission Control Function (NSACF) apparatus, first information related to an overloaded network slice;
means for receiving, from a User Equipment (UE), second information related to a first network slice;
means for determining whether the first network slice is overloaded based on the first information;
means for sending, to the UE, third information related to a second network slice in a case where the first network slice is overloaded; and
means for receiving, from the UE, a message to establish a Protocol Data Unit (PDU) session on the second network slice,
wherein the message includes the third information.

supplementary note 83. The AMF apparatus according to supplementary note 82, further comprising:
means for sending, to the UE, a reject cause value indicating that PDU session establishment on the first network slice is rejected due to an overload of the first network slice in a case where the first network slice is overloaded.

supplementary note 84. A User Equipment (UE) comprising:
means for sending, to an Access and Mobility management Function (AMF) apparatus, first information related to a first network slice;
means for receiving, from the AMF apparatus, second information related to a second network slice in a case where the first network slice is overloaded; and
means for sending, to the AMF apparatus, a message to establish a Protocol Data Unit (PDU) session on the second network slice,
wherein the message includes the second information.

supplementary note 85. The UE according to supplementary note 84, further comprising:
receiving, from the AMF apparatus, a reject cause value indicating that PDU session establishment on the first network slice is rejected due to an overload of the first network slice in a case where the first network slice is overloaded.
supplementary note 86. An Access and Mobility management Function (AMF) apparatus comprising:
means for receiving, from a Network Slice Admission Control Function (NSACF) apparatus, first information related to an overloaded network slice; and
means for sending, to a Radio Access Network (RAN) Node, the first information and second information indicating that the overloaded network slice is suspended for registration or service.

supplementary note 87. A Radio Access Network (RAN) Node comprising:
means for receiving, from an Access and Mobility management Function (AMF) apparatus, first information related to an overloaded network slice and second information indicating that the overloaded network slice is suspended for registration or service; and
means for stopping broadcasting the first information.

supplementary note 88. A Radio Access Network (RAN) Node comprising:
means for receiving, from an Access and Mobility management Function (AMF) apparatus, first information related to an overloaded network slice and second information indicating that the overloaded network slice is suspended for registration or service; and
means for broadcasting the first information in information element indicating a network slice suspended for the registration or the service.

supplementary note 89. An Access and Mobility management Function (AMF) apparatus comprising:
means for receiving, from a Network Slice Admission Control Function (NSACF) apparatus, first information related to an overloaded network slice;
means for receiving, from a User Equipment (UE), second information related to a first network slice;
means for determining whether the first network slice is overloaded based on the first information; and means for sending, to a Policy Control Function (PCF) apparatus, the second information to modify a Network Slice Selection Policy (NSSP) related to the first network slice in a case where the first network slice is overloaded.

supplementary note 90. A Policy Control Function (PCF) apparatus comprising:
means for receiving, from an Access and Mobility management Function (AMF) apparatus, information related to an overloaded network slice; and
means for modifying a Network Slice Selection Policy (NSSP) related to the overloaded network slice based on the information.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111028661, filed on Jun. 25, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 NSACF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
731 transceiver circuit
732 network interface
733 controller
734 memory
751 transceiver circuit
752 network interface
753 controller
754 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7341 operating system
7342 communications control module
7541 operating system
7542 communications control module
7741 operating system
7742 communications control module
60521 transceiver control module
61421 transceiver control module
62421 transceiver control module
70421 transceiver control module
71421 transceiver control module
73421 transceiver control module
75421 transceiver control module
77421 transceiver control module

What is claimed is:

1. A method of an Access and Mobility management Function (AMF), the method comprising:
receiving, from a User Equipment (UE), first Single Network Slice Selection Assistance Information (S-NSSAI); and
sending, to a Session Management Function (SMF), a second S-NSSAI during a Protocol Data Unit (PDU) session establishment procedure,
wherein the second S-NSSAI is used to replace the first S-NSSAI in a case where the first S-NSSAI is not available.

2. The method according to claim 1,
wherein the second S-NSSAI is sent to proceed the PDU session establishment procedure using the second S-NSSAI.

3. The method according to claim 1,
wherein the SMF is selected based on the second S-NSSAI.

4. The method according to claim 1, further comprising:
receiving notification in a case where the first S-NSSAI is available.

5. The method according to claim 1, further comprising:
receiving, from the UE, the second S-NSSAI.

6. The method according to claim 1, further comprising:
sending, to the UE, the second S-NSSAI.

7. The method according to claim 1, further comprising:
receiving, from a Policy Control Function (PCF), the second S-NSSAI.

8. A method of a User Equipment (UE), the method comprising:
communicating with an Access and Mobility management Function (AMF); and
sending, to the AMF during a Protocol Data Unit (PDU) session establishment procedure, first Single Network Slice Selection Assistance Information (S-NSSAI) and second S-NSSAI,
wherein the second S-NSSAI is used to replace the first S-NSSAI during the PDU session establishment procedure in a case where the first S-NSSAI is not available.

9. The method according to claim 8,
wherein the second S-NSSAI is sent to proceed the PDU session establishment procedure using the second S-NSSAI.

10. An Access and Mobility management Function (AMF) comprising:
at least one memory; and
at least one hardware processor coupled to the at least one memory,
wherein the at least one hardware processor is configured to:
receive, from a User Equipment (UE), first Single Network Slice Selection Assistance Information (S-NSSAI); and
send, to a Session Management Function (SMF), a second S-NSSAI during a Protocol Data Unit (PDU) session establishment procedure,
wherein the second S-NSSAI is used to replace the first S-NSSAI in a case where the first S-NSSAI is not available.

11. A User Equipment (UE) comprising:
at least one memory; and
at least one hardware processor coupled to the at least one memory,
wherein the at least one hardware processor is configured to:
communicate with an Access and Mobility management Function (AMF); and
send, to the AMF during a Protocol Data Unit (PDU) session establishment procedure, first Single Network Slice Selection Assistance Information (S-NSSAI) and second S-NSSAI,
wherein the second S-NSSAI is used to replace the first S-NSSAI during the PDU session establishment procedure in a case where the first S-NSSAI is not available.

12-56. (canceled)
